(19) United States
(12) Patent Application Publication
(10) Pub. No.: US 2015/0126115 A1
(43) Pub. Date: May 7, 2015

(54) METHOD OF REGISTERING USE OF MOBILE TERMINAL TO IMAGE FORMING APPARATUS, THE IMAGE FORMING APPARATUS USING THE METHOD, METHOD OF REQUESTING REGISTRATION OF USE OF THE MOBILE TERMINAL, AND THE MOBILE TERMINAL USING THE METHOD

(71) Applicant: Samsung Electronics Co., Ltd., Suwon-si (KR)

(72) Inventors: Chang-jung YUN, Suwon-si (KR); Sung-joon Park, Hwaseong-si (KR); Jin-hyung Kim, Suwon-si (KR); Hyun-wook Park, Suwon-si (KR)

(73) Assignee: Samsung Electronics Co., Ltd., Suwon-si (KR)

(21) Appl. No.: 14/592,483

(22) Filed: Jan. 8, 2015

Related U.S. Application Data
(63) Continuation-in-part of application No. 13/712,138, filed on Dec. 12, 2012.
(60) Provisional application No. 61/569,391, filed on Dec. 12, 2011.

(30) Foreign Application Priority Data
Jan. 9, 2014 (KR) 10-2014-0003091

(51) Int. Cl. H04W 76/02; H04W 12/06; H04B 5/00

(52) U.S. Cl. CPC H04W 76/023; H04B 5/0031; H04W 12/06
USPC 455/41.1

(57) ABSTRACT

A method of registering use of a mobile terminal that supports a near field communication (NFC) function, to an image forming apparatus, the image forming apparatus using the method, a method of requesting registration of the use of the mobile terminal supporting the NFC function, and the mobile terminal using the method, which enable registration of use of the mobile terminal to the image forming apparatus without a manager when the mobile terminal performs initial NFC with the image forming apparatus by NFC tagging.

### CROSS-REFERENCE TO RELATED APPLICATIONS

This application is a continuation in part of U.S. patent application Ser. No. 13/712,138, filed on Dec. 12, 2012, which claims the priority benefit under 35 USC §120 from U.S. Provisional Patent Application No. 61/569,391, filed on Dec. 12, 2011, in the U.S. Patent and Trademark Office, and claims the priority benefit of Korean Patent Application No. 10-2014-0003091, filed on Jan. 9, 2014, in the Korean Intellectual Property Office, the disclosures of which are incorporated herein by reference.

### BACKGROUND

1. Field

The following description relates to a method of registering a use of a mobile terminal supporting a near field communication (NFC) function to an image forming apparatus, the image forming apparatus using the method, a method of requesting registration of the use of the mobile terminal supporting the NFC function, and the mobile terminal using the method.

2. Description of the Related Art

Near field communication (NFC) is a contactless short-range wireless communication standard between electronic devices within a short (approximately 10 cm) distance from each other with low power consumption and using a frequency of 13.56 MHz, and was developed by the joint work of NXP Semiconductors of the Netherlands and Sony of Japan in 2002. A data transfer rate of NFC is 424 Kbps, and NFC has excellent security due to high proximity and encryption technology. NFC forgoes a complicated pairing process of recognition of devices and allows devices to recognize one another within 1/10 of a second or less.

In particular, NFC is a smart card type contactless wireless communication technology where radio frequency identification (RFID) technology is utilized. In addition, NFC builds upon RFID technology by allowing two-way communication compared to smart cards. NFC has a relatively large memory storage space and offers a variety of services. Accordingly, commercialized electronic devices, such as smartphones and personal computers (PCs), in which NFC technology is used, have recently been released.

To register a use of an external device supporting an NFC function to a device such as an image forming apparatus, a complicated process of registering the use of the external device to the image forming apparatus is carried out via a manager.

### SUMMARY

One or more embodiments of the present disclosure include a method of registering a use of a mobile terminal supporting a near field communication (NFC) function to an image forming apparatus, the image forming apparatus using the method, a method of requesting registration of the use of the mobile terminal supporting the NFC function, and the mobile terminal using the method.

Additional aspects will be set forth in part in the description which follows and, in part, will be apparent from the description, or may be learned by practice of the presented embodiments.

According to one or more embodiments of the present disclosure, an image forming apparatus that registers a use of a mobile terminal that supports a near field communication (NFC) function includes an NFC module for performing NFC with the mobile terminal by NFC tagging; a control unit for receiving use registration information including user information from the mobile terminal by using the NFC module and performing user authentication for registering use of the mobile terminal based on the received use registration information; a storage unit for storing the use registration information whose user authentication is completed; and a user interface (UI) unit for displaying a use registration result.

The use registration information may include device information used to identify the mobile terminal.

The control unit may perform user authentication by decrypting the use registration information encrypted by an application that is executed in the mobile terminal and inputs the user information.

The storage unit may store a user profile used to perform user authentication, and the control unit may perform user authentication by comparing the user information included in the received use registration information with the user profile.

The image forming apparatus may further include: a communication module for performing communication with a server in which a user profile used to perform user authentication is stored, wherein the control unit performs user authentication by transmitting the user information included in the received use registration information to the server, requesting the server for user authentication, and receiving a use registration result from the server.

The image forming apparatus may further include: a communication module for performing wireless communication that is different from the NFC performed by the NFC module, wherein the control unit receives the use registration information from the mobile terminal by using one of the NFC module and the communication module and performs user authentication for registering use of the mobile terminal based on the received use registration information.

The control unit may transmit a wireless communication method used to perform the wireless communication with the mobile terminal by using the NFC module and receives the use registration information by the transmitted wireless communication method by using the communication module.

The image forming apparatus may further include: a communication module for performing wireless communication that is different from the NFC performed by the NFC module, wherein the control unit receives the use registration information from the mobile terminal by using the communication module when NFC performed using the NFC module is stopped and performs user authentication for registering use of the mobile terminal based on the received use registration information.

The control unit may receive the use registration information from the mobile terminal by using the communication module when the mobile terminal goes beyond a predetermined distance and NFC performed using the NFC module is stopped.

A method of registering a use of a mobile terminal that supports a near field communication (NFC) function, to an image forming apparatus may include performing NFC with the mobile terminal by NFC tagging, and receiving use registration information including user information from the mobile terminal; performing user authentication for registering use of the mobile terminal based on the received use registration information; storing the use registration information whose user authentication is completed; and displaying a use registration result.

According to one or more embodiments of the present disclosure, a mobile terminal supporting a near field communication (NFC) function may include an application executing unit for executing an application that inputs user information used to perform user authentication for registering use of the mobile terminal to an image forming apparatus; a user interface (UI) unit for receiving the user information; an NFC module for performing NFC with the image forming apparatus by NFC tagging; and a control unit for transmitting use registration information including the input user information to the image forming apparatus by using the NFC module and receiving a result of use registration of the mobile terminal from the image forming apparatus in response to transmission of the use registration information.

The use registration information may include device information used to identify the mobile terminal.

The control unit may transmit the use registration information encrypted by the application by using the NFC module.

The mobile terminal may further include: a communication module for performing wireless communication that is different from the NFC performed by the NFC module, wherein the control unit transmits the use registration information to the image forming apparatus by using one of the NFC module and the communication module and receives a result of use registration of the mobile terminal from the image forming apparatus in response to transmission of the use registration information.

The control unit may determine a module to perform communication from among the NFC module and the communication module based on at least one selected from the group consisting of a distance between the image forming apparatus and the mobile terminal, a data rate of the use registration information, and a communication state of the image forming apparatus and the mobile terminal.

The control unit may obtain a wireless communication method used to perform the wireless communication with the image forming apparatus by using the NFC module and transmits the use registration information by the obtained wireless communication method by using the communication module.

The control unit may request the image forming apparatus for communication by using the NFC module and receives a wireless communication method that is different from the NFC performed by the NFC module in response to a request to obtain the wireless communication method used to perform the wireless communication with the image forming apparatus.

The mobile terminal may further include: a communication module for performing wireless communication that is different from the NFC performed by the NFC module, wherein the control unit transmits the use registration information to the image forming apparatus by using the communication module when NFC performed using the NFC module is stopped and receives a result of use registration of the mobile terminal from the image forming apparatus in response to the transmission of the use registration information.

The control unit may transmit the use registration information to the image forming apparatus by using the communication module when the mobile terminal goes beyond a predetermined distance and NFC performed using the NFC module is stopped.

According to one or more embodiments of the present disclosure, a method of registering use of a mobile terminal supporting an NFC function to an image forming apparatus may include executing an application that inputs user information used to perform user authentication for registering use of the mobile terminal to the image forming apparatus; receiving the user information; performing NFC with the image forming apparatus by NFC tagging, and transmitting use registration information including the input user information to the image forming apparatus; and receiving a result of use registration of the mobile terminal from the image forming apparatus in response to transmission of the use registration information.

### BRIEF DESCRIPTION OF THE DRAWINGS

These and/or other aspects will become apparent and more readily appreciated from the following description of the embodiments, taken in conjunction with the accompanying drawings of which:

FIG. 1 is a diagram illustrating devices supporting Wi-Fi Direct and legacy wireless local area network (WLAN) devices that are wirelessly connected to each other to form a wireless network according to an embodiment of the present general inventive concept;

FIG. 2 is a diagram illustrating processes of wirelessly connecting the devices supporting the Wi-Fi Direct to each other according to an embodiment of the present general inventive concept;

FIG. 3 is a diagram illustrating an example of displaying a list of Wi-Fi Direct devices that are found after a device discovery process performed by a device supporting the Wi-Fi Direct;

FIG. 4 is a diagram illustrating a group formation process in the processes of connecting the Wi-Fi Direct supporting devices to each other according to an embodiment of the present general inventive concept;

FIG. 5 is a diagram illustrating a display screen to execute WPS according to an embodiment of the present general inventive concept;

FIG. 6 is a diagram illustrating a list of devices supporting Wi-Fi Direct and information of which is stored according to a profile storing function;

FIG. 7 is a diagram illustrating Wi-Fi Direct supporting devices that are simultaneously connected to each other according to an embodiment of the present general inventive concept;

FIG. 8 is a block diagram illustrating a hardware configuration of a multi-function printer supporting the Wi-Fi Direct according to an embodiment of the present general inventive concept;

FIG. 9 is a block diagram illustrating a software program configuration of the multi-function printer supporting the Wi-Fi Direct of FIG. 8 according to an embodiment of the present general inventive concept;

FIG. 10 is a detailed block diagram illustrating a software program configuration of a multi-function printer supporting the Wi-Fi Direct according to an embodiment of the present general inventive concept;

FIG. 11 is a detailed block diagram illustrating the multi-function printer supporting the Wi-Fi direct according to the embodiment of the present general inventive concept;

FIGS. 12, 13a, and 13B are flowcharts illustrating a method of activating Wi-Fi Direct in the multi-function printer supporting Wi-Fi Direct of FIG. 11 according to an embodiment of the present general inventive concept;

FIG. 14 is a detailed block diagram illustrating a multi-function printer supporting Wi-Fi Direct according to an embodiment of the present general inventive concept;

FIG. 15 is a flowchart illustrating a method of performing image forming processes in the multi-function printer supporting Wi-Fi Direct of FIG. 14, according to an embodiment of the present general inventive concept;

FIG. 16 is a block diagram illustrating a software program configuration of a multi-function printer supporting the Wi-Fi Direct according to an embodiment of the present general inventive concept;

FIG. 17 is a detailed block diagram illustrating a multi-function printer supporting Wi-Fi Direct according to an embodiment of the present general inventive concept;

FIGS. 18 through 23 are flowcharts illustrating a method of managing channels in a multi-function printer supporting Wi-Fi Direct according to an embodiment of the present general inventive concept;

FIG. 24 is a detailed block diagram illustrating a multi-function printer supporting Wi-Fi Direct according to an embodiment of the present general inventive concept;

FIGS. 25 through 27 are flowcharts illustrating a method of changing an operation mode in the multi-function printer supporting Wi-Fi Direct according to an embodiment of the present general inventive concept;

FIG. 28 illustrates an image forming apparatus and a mobile terminal that perform near field communication (NFC), according to an embodiment of the present disclosure;

FIG. 29 illustrates three communication modes of NFC;

FIG. 30 illustrates a structure of a mobile terminal supporting an NFC function, according to an embodiment of the present disclosure;

FIG. 31 illustrates a result of a mobile terminal executing an application that inputs user information used to perform user authentication for registering use of the mobile terminal to an image forming apparatus, according to an embodiment of the present disclosure;

FIG. 32 illustrates a structure of an image forming apparatus according to an embodiment of the present disclosure;

FIG. 33 illustrates an image forming apparatus and a mobile terminal that perform NFC and other wireless communication methods;

FIG. 34 illustrates a comparison of data rates and communication ranges of NFC and other wireless communication methods;

FIG. 35 illustrates a structure of a mobile terminal supporting an NFC function according to an embodiment of the present disclosure;

FIG. 36 illustrates a structure of an image forming apparatus according to an embodiment of the present disclosure;

FIG. 37 illustrates a method in which a mobile terminal supporting an NFC function requests an image forming apparatus to register use thereof, and the image forming apparatus registers use of the mobile terminal, according to an embodiment of the present disclosure;

FIG. 38 illustrates a method in which a mobile terminal supporting an NFC function requests an image forming apparatus to register use thereof, and the image forming apparatus registers use of the mobile terminal, according to an embodiment of the present disclosure;

FIG. 39 illustrates a method in which a mobile terminal supporting an NFC function requests an image forming apparatus to register use thereof, and the image forming apparatus registers use of the mobile terminal, according to an embodiment of the present disclosure;

FIG. 40 illustrates a method in which a mobile terminal supporting an NFC function requests an image forming apparatus to register use thereof, and the image forming apparatus registers use of the mobile terminal, according to an embodiment of the present disclosure;

FIG. 41 illustrates a method in which a mobile terminal supporting an NFC function requests an image forming apparatus to register use thereof, and the image forming apparatus registers use of the mobile terminal, according to an embodiment of the present disclosure;

FIG. 42 illustrates a method of registering use of a mobile terminal to an image forming apparatus, according to an embodiment of the present disclosure; and

FIG. 43 illustrates a method of requesting an image forming apparatus to register use of a mobile terminal, according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

In the following descriptions of the embodiments, expressions or terms such as “constituted by,” “formed by,” “include,” “comprise,” “including,” and “comprising” should not be construed as always including all specified elements, processes, or operations, but may be construed as not including some of the specified elements, processes, or operations, or further including other elements, processes, or operations.

In addition, although the terms “first and second” are used to describe various elements, these elements should not be limited by these terms. These terms are only used to distinguish one element from another element.

Hereinafter, a multi-function printer (MFP) that supports Wi-Fi Direct will be described as an example of an image forming apparatus supporting a peer-to-peer (P2P) connection. However, the scope of the present general inventive concept to be protected is not limited thereto, but is defined by descriptions of claims.

Before describing embodiments of the present general inventive concept, a basic connections and operations of an MFP that supports the Wi-Fi Direct will be described with reference to accompanying drawings.

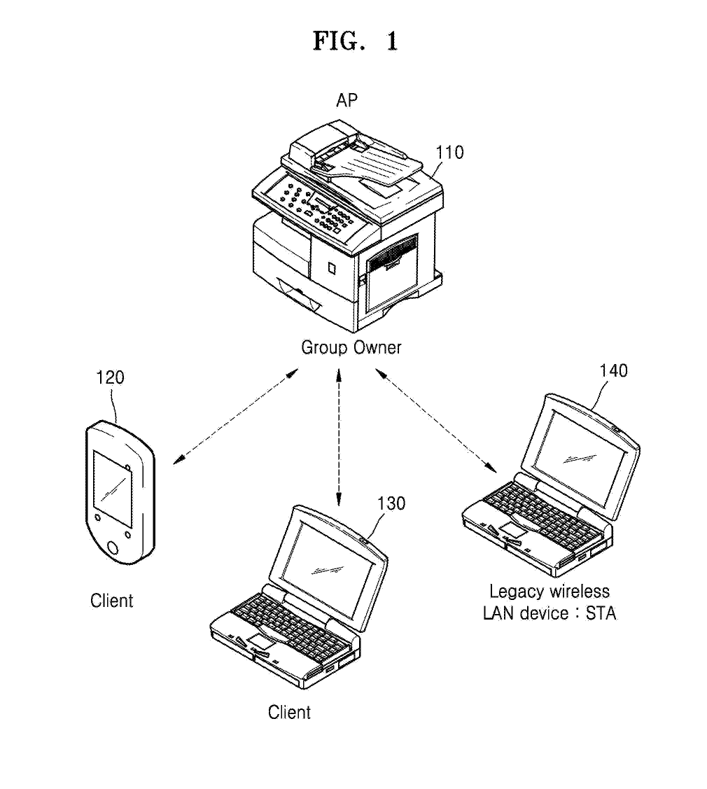

FIG. 1 is a diagram illustrating wireless local area network (WLAN) devices supporting Wi-Fi Direct and a legacy WLAN device connecting to each other to form a wireless network according to an embodiment of the present general inventive concept. Referring to FIG. 1, an MFP 110 supporting the Wi-Fi Direct is wirelessly connected to a smartphone 120 supporting the Wi-Fi Direct, a laptop computer 130 supporting the Wi-Fi Direct, and a legacy WLAN laptop computer 140. Here, the legacy WLAN laptop computer 140 denotes a conventional laptop computer which adopts a WLAN technology and does not support the Wi-Fi Direct.

The WLAN device supporting the Wi-Fi Direct (hereinafter, referred to as “Wi-Fi Direct device”) may perform a P2P connection without using an infrastructured network, unlike conventional devices supporting Wi-Fi. According to the conventional Wi-Fi technology, a Wi-Fi device is wirelessly connected to a router, that is, an access point (AP) connected to an infrastructured network that is configured in advance in order to form a wireless network. Here, the Wi-Fi devices, which are wirelessly connected to the AP of the infrastructure network, function as stations. However, according to Wi-Fi Direct technology, one of the Wi-Fi Direct devices that are to form a wireless network may operate as an AP of a Wi-Fi Direct network, and the other Wi-Fi Direct devices are wirelessly connected to the Wi-Fi Direct device that operates as the AP such that the other Wi-Fi Direct devices operate as stations. Therefore, the wireless network may be formed between the Wi-Fi direct devices without the AP connected to the infrastructured network. In addition, when the wireless network is formed between the Wi-Fi direct devices, the legacy WLAN devices, such as the Wi-Fi devices, may recognize that the Wi-Fi direct device operates as an AP and may be wirelessly connected to the Wi-Fi direct device.

Referring to FIG. 1, the Wi-Fi Direct MFP 110, the Wi-Fi Direct smartphone 120, and the Wi-Fi Direct laptop computer 130 that are the Wi-Fi direct devices form a wireless network without an AP connected to the infrastructured network. As described above, the Wi-Fi direct devices may be wirelessly connected to each other to form a P2P group without an AP connected to the infrastructured network. Here, the Wi-Fi Direct MFP 110 operates as the AP, and the device operating as the AP among the Wi-Fi direct devices is referred to as a group owner (GO) of a P2P group. In addition, the Wi-Fi smartphone 120 and the Wi-Fi Direct laptop computer 130 are wirelessly connected to the GO, that is, the Wi-Fi Direct MFP 110, to operate as the stations, which are referred to as clients. On the other hand, the legacy WLAN laptop computer 140 that does not support the Wi-Fi Direct recognizes that the GO, that is, the Wi-Fi Direct MFP 110, as the AP, and is wirelessly connected to the GO to be connected to the wireless network formed by the Wi-Fi direct devices.

Although FIG. 1 illustrates the Wi-Fi Direct MFP 110 to operate as the GO, any one of the other Wi-Fi direct devices, that is, the smartphone 120 and the laptop computer 130, may operate as the GO and the MFP 110 may operate as the client. A determination of which of the Wi-Fi direct devices becomes the GO can be made through a negotiation process in Wi-Fi direct connection processes, and this will be described in detail later. Meanwhile, the Wi-Fi direct device may be the GO by itself before the connection without any negotiation with other Wi-Fi Direct device, and the Wi-Fi direct device in this case is referred to as an autonomous group owner (AGO). In addition, a wireless network formed based on the AGO is referred to as an autonomous P2P group. When the autonomous P2P group is formed, the legacy WLAN device may recognize the AGO as an AP connected to the infrastructured network and may be connected to the AGO.

Although FIG. 1 illustrates an example in which the Wi-Fi direct devices form the P2P group without the AP connected to the infrastructured network, the Wi-Fi direct devices may operate as the stations by connecting to the AP, if the AP is connected to the infrastructured network.

Hereinafter, wireless connecting processes between the Wi-Fi direct devices and characteristics of the Wi-Fi Direct technology will be described with reference to the accompanying drawings. For convenience of description, an MFP supporting the Wi-Fi Direct (hereinafter, referred to as “Wi-Fi Direct MFP”) will be described as an example; however, the present general inventive concept is not limited thereto, that is, embodiments of the present general inventive concept may be applied to printers, scanners, or facsimiles supporting the Wi-Fi Direct. In addition, the Wi-Fi Direct is used as an example of the P2P communication method; however, other P2P communication methods, such as Bluetooth and Zigbee, may be used within the applicable range of the present general inventive concept.

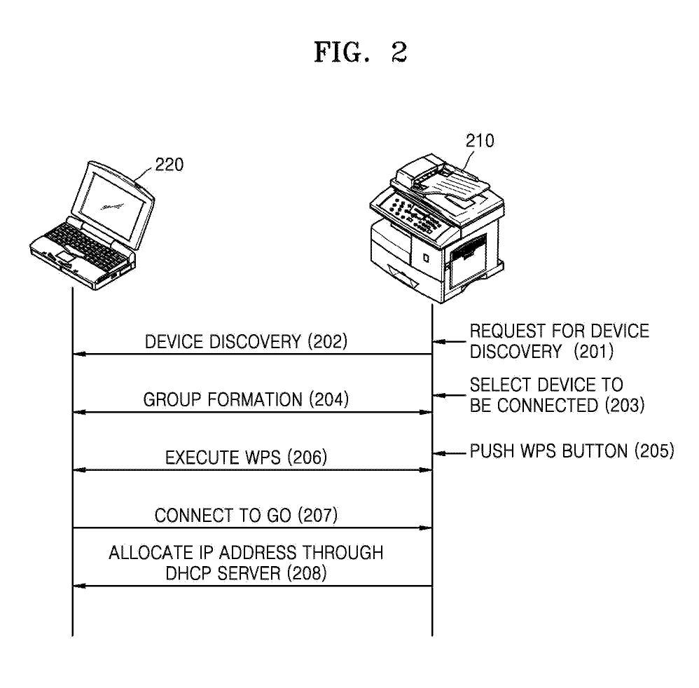

FIG. 2 is a diagram illustrating processes of wirelessly connecting Wi-Fi Direct devices to each other. The processes of Wi-Fi Direct connection between a Wi-Fi Direct MFP 210 and a Wi-Fi Direct laptop computer 220 are illustrated hereinafter. The Wi-Fi Direct connecting processes may be divided as a device discovery process, a group formation process, and a secure connection process. Referring to FIG. 2, the Wi-Fi Direct MFP 210 receives a request for a device discovery from a user, and searches for a Wi-Fi Direct device around the Wi-Fi Direct MFP 210 at operation 202. The device discovery request may be input through a user interface of the MFP 210, for example, a user interface realized on a display unit, such as a liquid crystal display (LCD), formed in the MFP 210. If it is determined as a result of searching that there is a Wi-Fi Direct device around the MFP 210, the MFP 210 shows the user the searched device through the display unit and receives a connection request 203 from the user. The connection request 203 may be also input through the display unit of the MFP 210 from the user, for example, the user may push buttons or a touch panel of the display unit. If there are a plurality of Wi-Fi Direct devices, the MFP 210 displays a list of the searched Wi-Fi direct devices on the display unit so that the user may select one of the Wi-Fi direct devices and request the connection to the selected Wi-Fi direct device.

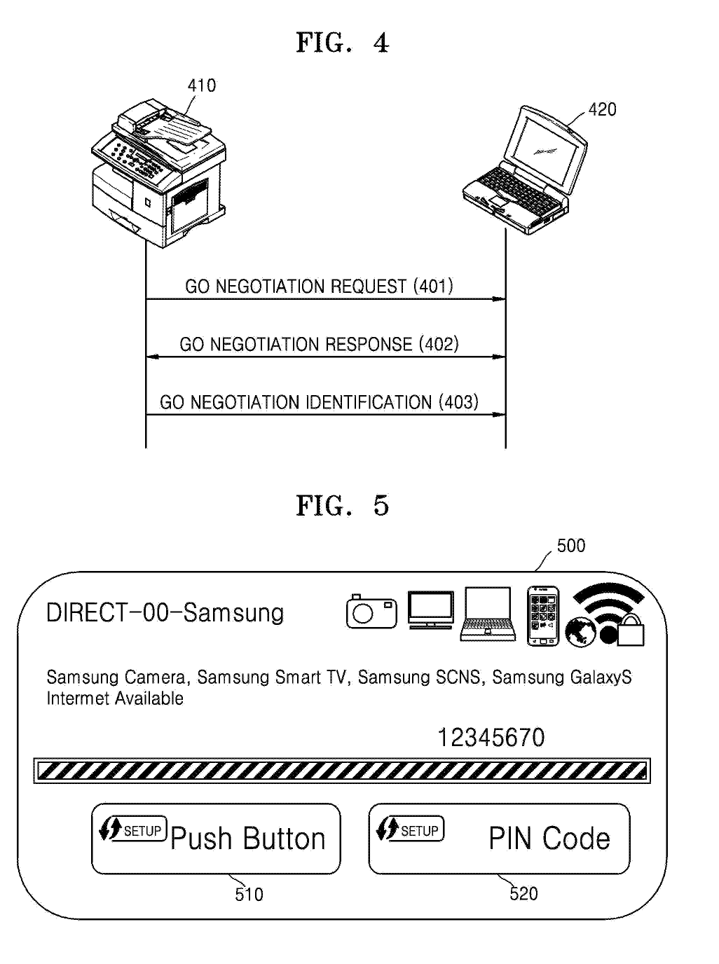

After receiving the connection request at operation 203, a group formation is performed between the Wi-Fi Direct devices to be connected at operation 204. The group formation process determines the Wi-Fi Direct devices to be connected to each other and determines the Wi-Fi direct devices to be the GO or the clients in the group. The Wi-Fi Direct device to be the GO is determined through the negotiation between the Wi-Fi Direct devices, and the negotiation will be described in detail with reference to FIG. 4.

When the group is formed, the devices included in the group are to be securely connected to each other by using a Wi-Fi protected setup (WPS) technology. The WPS denotes a function of performing simple secure connection between the Wi-Fi supporting devices. The WPS may be classified as a personal identification number (PIN) type WPS and a push button configuration (PBC) type WPS. The PIN type WPS sets the secure connection by inputting a PIN code that is set in advance, and the PBC type WPS sets the secure connection by pushing a WPS button that is provided on the Wi-Fi Direct device.

Hereinafter, the PBC type WPS will be described as an example. The user pushes a WPS button provided on the MFP 210 to request the secure connection at operation 205. In addition, within a predetermined period of time (for example, 120 seconds), the secure connection may be achieved by pushing a WPS button formed on the laptop computer 220, or a WPS button realized on an application program for Wi-Fi Direct connection in the laptop computer 220. The WPS button realized on the application program for the Wi-Fi Direct connection in the laptop computer 220 may be an object represented on a display unit of the laptop computer 220 by the application program for the Wi-Fi Direct connection. A detailed example of the WPS button is represented as reference numeral 510 in FIG. 5. The user clicks the WPS button represented on the display unit of the laptop computer 220 by using a mouse, for example, to request the secure connection. When the secure connection is requested by pushing the WPS button, the device that is determined to be the GO in the group formation process transmits secure information to devices determined as the clients at operation 206. According to the Wi-Fi Direct, the secure connection is executed after encrypting in a Wi-Fi protected access 2 (WPA2)-pre-shared key (PSK) method, and thus, the Wi-Fi Direct may have a higher security function than that of a conventional wired equivalent privacy (WEP) or Wi-Fi protected access (WAP) method.

When the WPS is executed, the Wi-Fi direct device that is the client is connected to the Wi-Fi direct device that is the GO at operation 207. At this time, the Wi-Fi Direct device that is the GO automatically allocates an Internet protocol (IP) address to the Wi-Fi direct device that is the client by using a dynamic host configuration protocol (DHCP) server at operation 208, and then, the P2P connection between the Wi-Fi Direct devices is completed.

Basic processes for connecting the Wi-Fi direct devices have been described so far, and detailed processes and characteristics of the Wi-Fi Direct technology will be described with reference to the accompanying drawings as follows.

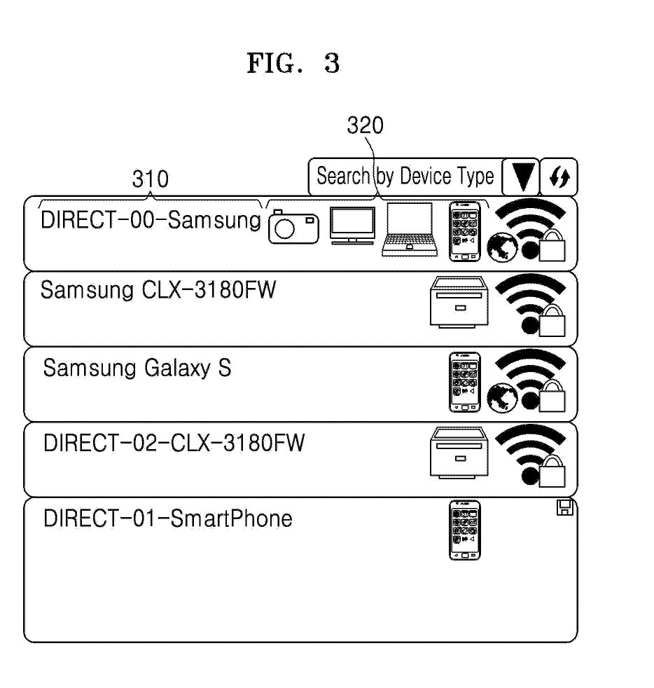

FIG. 3 is a diagram illustrating an example of displaying a list of the Wi-Fi Direct devices that are searched in the device discovery process in the Wi-Fi Direct device. When the device discovery process is performed by the Wi-Fi direct device, device information, such as a type of the device and a service set identifier (SSID) of the device, is exchanged between the devices through a probe request and a probe response that are WLAN packets, and the Wi-Fi direct device that performs the device discovery process displays the collected information. As shown in FIG. 3, the SSIDs and the types of the searched Wi-Fi Direct devices are represented as text or icons. Here, all of the searched devices may be represented in the list; however, the devices may be filtered so that the devices of a desired type may be only displayed in the list. According to the Wi-Fi Direct technology, the Wi-Fi direct devices are defined in category units. The Wi-Fi Direct devices may be classified as categories, for example, computers, input devices, printers, scanners, facsimiles, copying machines, and cameras, and each of the categories is divided into sub-categories. For example, the computer may be classified as personal computers (PCs), servers, laptop computers, and the like.

FIG. 4 is a diagram illustrating the group formation process in detail among the connecting processes between the Wi-Fi Direct devices. The group formation process is a process of determining the Wi-Fi Direct devices that are to form a network, and the Wi-Fi Direct devices to be the GO and the clients. For example, when the Wi-Fi direct MFP 410 performs the device discovery and selects a laptop computer 420 among the discovered Wi-Fi Direct devices to be connected, the MFP 410 transmits a GO negotiation request to the laptop computer 420 at operation 401. The laptop computer 420 receiving the GO negotiation request compares an intent value thereof with that of the MFP 410, and then, determines the MFP 410 as the GO when the intent value of the MFP 410 is greater than that of the laptop computer 420 and determines the laptop computer 420 as the GO when the intent value of the laptop computer 420 is greater than that of the Wi-Fi direct MFP 410. Here, the intent value is a value representing a degree of task intent in each device, and is determined according to a design or user preference and setting. The intent value of the device, which is always supplied power, may be set to be relatively high. As described above, after determining the Wi-Fi Direct device to be the GO by comparing the intent values, the laptop computer 420 transmits the determination result to the MFP 410 as a response to the GO negotiation at operation 402. The MFP 410 that receives the determination result transmits an acknowledgement to the laptop computer 420 at operation 403 in order to verify the receipt of the negotiation, and then, the group formation process is finished. When the group formation is completed, the Wi-Fi Direct device that is the GO manages secure information and SSIDs of the other Wi-Fi Direct devices included in the group.

When the group is formed, the Wi-Fi Direct devices included in the group are securely connected to each other through the WPS. FIG. 5 is a diagram illustrating a display screen 500 to provide an interface to a user to execute the WPS. The display screen 500 of FIG. 5 may be displayed on a display unit of the Wi-Fi Direct MFP. Referring to FIG. 5, the user may select one of a WPS button 510 and a PIN code 520 to execute the WPS. When the WPS is executed through the WPS button 510, the WPS button 510 of the Wi-Fi Direct MFP is pushed and WPS buttons of other devices are pushed within a predetermined period of time, and then, secure information is exchanged between the devices automatically and the secure connection is made. Here, the Wi-Fi Direct device that is the GO provides secure information to the Wi-Fi direct devices that are the clients. In addition, the secure connection is performed after encrypting in the WPA2-PSK verification method, and thus, high security may be achieved.

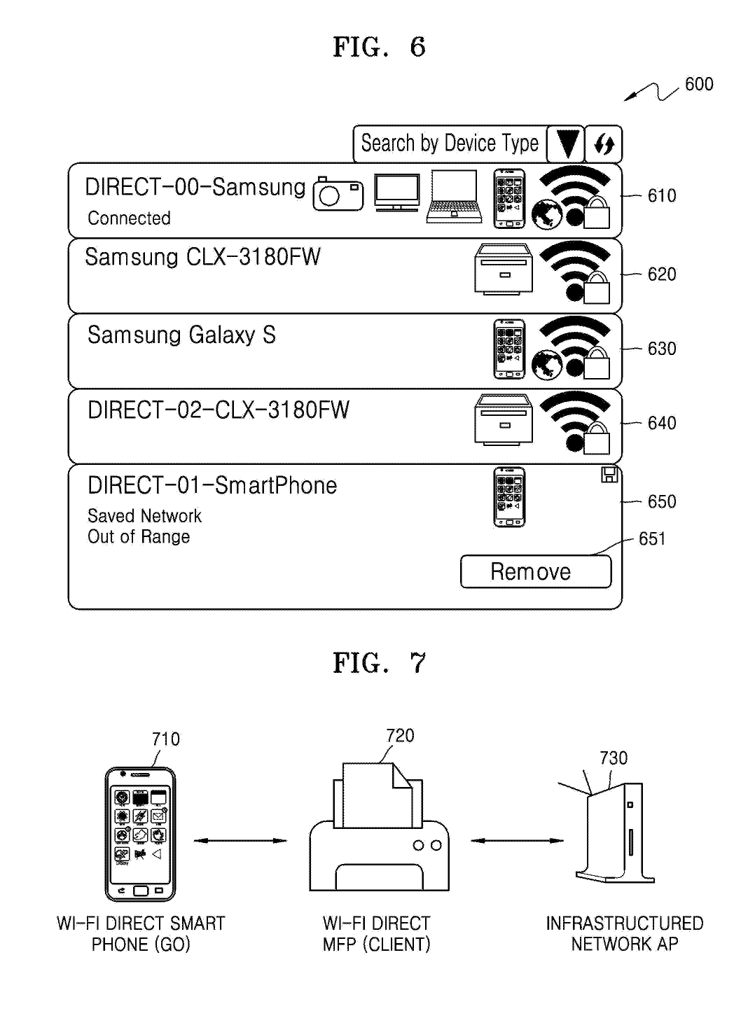

The Wi-Fi Direct devices have a profile storage function that is for storing information of the Wi-Fi Direct devices connected once thereto. FIG. 6 is a diagram illustrating a list of the Wi-Fi Direct devices with information of which is stored according to the profile storage function. The list of FIG. 6 is a screen displayed on the display unit of the Wi-Fi Direct MFP. Information of a first list 610 denotes a Wi-Fi Direct device currently connected to the Wi-Fi Direct MFP, information of second through fourth lists 620-640 denotes Wi-Fi Direct devices that are not currently connected to the Wi-Fi Direct MFP, but are included in a device discovery range of the Wi-Fi Direct MFP, and information of a fifth list 650 denotes a Wi-Fi Direct device that has been connected at least once to the Wi-Fi Direct device although that is not discovered currently. If the information of the fifth list 650 is not necessary, the user may delete the fifth list 650 by pushing a remove button 651. Since the Wi-Fi direct device has the profile storage function as described above, the Wi-Fi Direct device stores information of the other Wi-Fi Direct devices connected at least once thereto, and then, may be connected in a high speed and/or in a short period of time without executing the WPS by using the stored information in a case where the same device attempts to connect thereto again.

The Wi-Fi Direct device may be P2P connected to another Wi-Fi direct device, and at the same time, may be connected to the infrastructured network, which is referred to as a concurrent connection. FIG. 7 is a diagram illustrating the Wi-Fi Direct devices that are in the concurrent connection states. Referring to FIG. 7, the Wi-Fi direct MFP 720 is P2P connected to a smartphone 710 that is another Wi-Fi direct device, and at the same time, the Wi-Fi Direct MFP 720 is also connected to an AP 730 of the infrastructured network. The Wi-Fi Direct MFP 720 may directly transmit/receive print data to/from the smartphone 710, and at the same time, may directly transmit/receive print data to/from the infrastructured network through the AP 730 of the infrastructured network.

When the Wi-Fi direct device is concurrently connected to the Wi-Fi Direct device and the infrastructured network as shown in FIG. 7, or when the Wi-Fi Direct device is wired connected to the infrastructured network and P2P connected to another Wi-Fi direct device, different IP addresses and MAC addresses with respect to the connections, that is, the connection to the infrastructured network and the connection to the another Wi-Fi Direct device, may be used. Through a multi-homing technology, the Wi-Fi Direct device may provide the devices with different services from each other. For example, the Wi-Fi Direct MFP may provide services of all functions of the MFP through an interface connected to the infrastructured network; however, the Wi-Fi Direct MFP may provide services of partial functions of the MFP through an interface connected to another Wi-Fi Direct device.

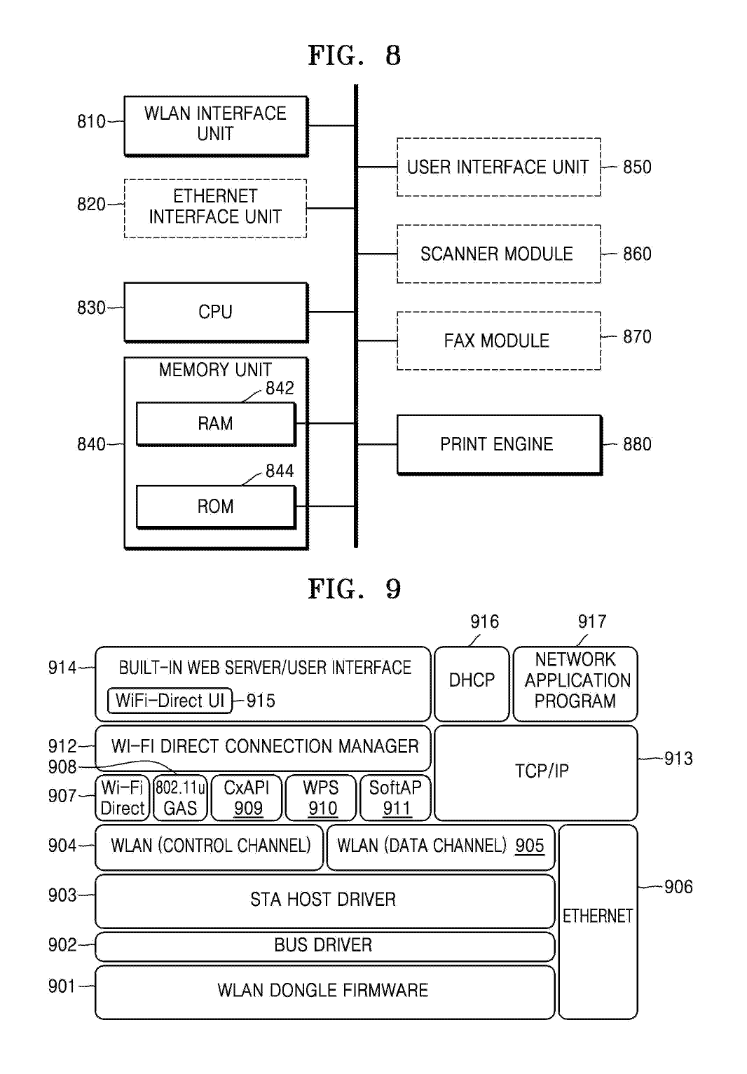

FIG. 8 is a block diagram illustrating a hardware configuration of the Wi-Fi Direct MFP. Referring to FIG. 8, the Wi-Fi Direct MFP may include a WLAN interface module 810, an Ethernet interface module 820, a central processing unit or a processing unit (CPU) 830, a memory unit 840, a user interface module 850, a scanner module 860, a fax module 870, and a print engine 880. The memory unit 840 may include a random access memory (RAM) 842 and a read only memory (ROM) 844. The memory unit 840 may include one or more semiconductor chips or one or more semiconductor chip packages in which a plurality of semiconductor chips are mounted on a substrate thereof. If the MFP only supports the WLAN, the MFP may not include the Ethernet interface module 820. In addition, if the device is a printer, rather than the MFP, the scanner module 860 and the fax module 870 are not necessary.

The WLAN interface module 810 is hardware to perform an IEEE 802.11b/g/n function, and may communicate with a main board, on which the CPU 830 is mounted, of the MFP via a universal serial bus (USB). The Ethernet interface module 820 is hardware to perform wired Ethernet communication according to IEEE 802.3. The CPU 830 controls overall operations of the MFP. The memory unit 840 stores information to control the MFP and the print data to be read if necessary. The user interface module 850 functions as a medium for the user to identify information of the MFP and to input commands into the MFP. The user interface module 850 may be variously modified according to products, for example, may be configured as two or four lines displayed on a display unit, such as an LCD or a light emitting diode (LED), or may be realized as a graphic user interface (UI) so as to represent various graphics. The scanner module 860, the fax module 870, and the print engine 880 are hardware to perform functions of a scanner, a facsimile, and a printer. The print engine 880 may include electrical and mechanical components to print an image on a print medium according to the data stored in the memory unit 840 or received from an external wireless device through the WLAN and/or Wi-Fi-Direct.

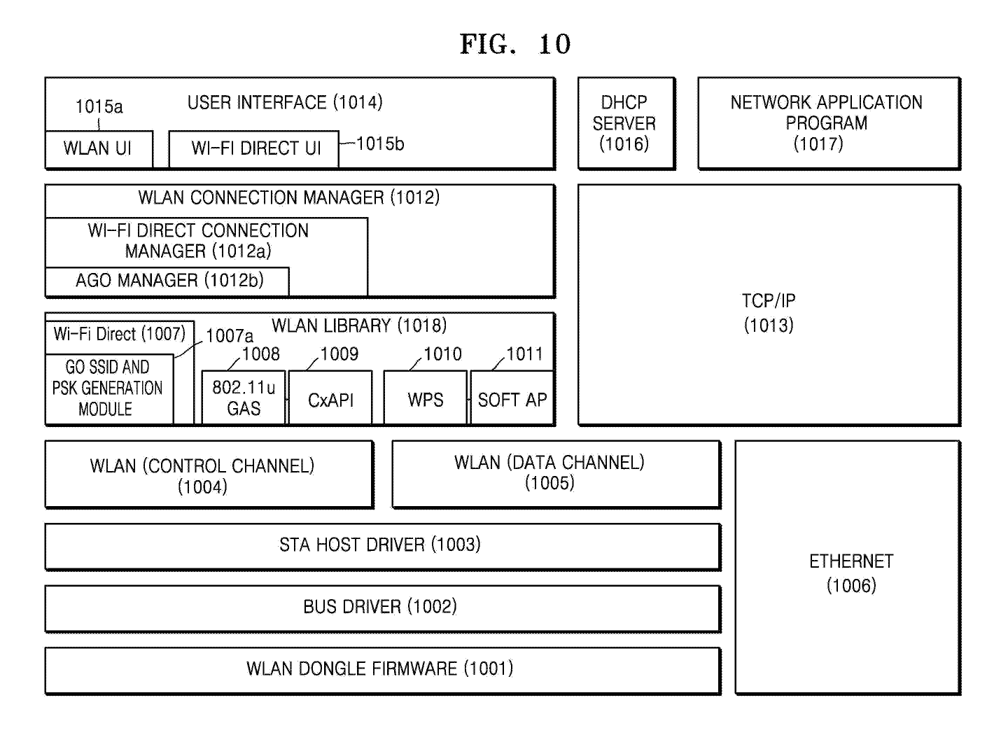

FIG. 9 is a block diagram illustrating a software program configuration of the Wi-Fi Direct MFP. The configuration of the software program in the Wi-Fi Direct MFP will be described with reference to FIG. 9 as follows.

A WLAN dongle firmware 901 is firmware to connect the WLAN, and may be stored in WLAN dongle hardware or may be transmitted to the WLAN dongle hardware from a main board of the MFP when booting the MFP. A bus driver 902 and a STA (station) host driver 903 are low level bus drivers to communicate with the WLAN hardware. A WLAN controlling channel 904 and a WLAN data channel 905 are channels to communicate with the WLAN firmware. A Wi-Fi Direct module 907 performs the Wi-Fi Direct connection and transmits an operating command to the WLAN firmware. An IEEE 802.11u generic advertisement service (GAS) module 908 performs functions according to IEEE 802.11u GAS, a module 909 performs functions relating to CxAPI, and a WPS module 910 performs a WPS function. A soft AP module 911 is a software program module to allow the MFP to perform as the AP. A transmission control protocol (TCP)/IP 913 is a standard protocol for network transmission. A Wi-Fi Direct connection manager 912 is a module to control the Wi-Fi Direct connection. A Wi-Fi Direct user interface 915 allows the user to perform settings related to the Wi-Fi Direct, and may be included in a user interface 914 that is installed in an embedded web server (EWS). A DHCP server 916 automatically allocates an IP address to the Wi-Fi Direct device that is connected as a client. A network application program 917 performs various application operations relating to the network.

The above-described Wi-Fi Direct technology provides the Wi-Fi Direct device and/or the devices of the wireless network with the following advantages:

A Wi-Fi Direct device may be connected to other devices whenever and wherever, and thus, the Wi-Fi Direct device has maximum mobility and portability. If a new Wi-Fi Direct device is added, the Wi-Fi Direct device may be directly connected to the new Wi-Fi direct device. In addition, it may be identified whether there is an available device or service before setting the connection to other devices, and thus, the Wi-Fi direct devices may be conveniently used. In addition, the connection may be performed simply and stably by a simple operation, for example, pushing a WPS button, and the connection may be performed with highly secure functions by using WPA2 technology.

In addition, the Wi-Fi Direct technology may provide various functions in addition to functions provided by the conventional WLAN technology.

For example, the device discovery function to search for peripheral Wi-Fi Direct devices by a device type unit, the service discovery function that may search for services provided by the peripheral Wi-Fi Direct devices, a power management function that may effectively use electric power, the concurrent connection function that may form the P2P connection between the Wi-Fi Direct devices while connecting to a conventional infrastructured network, a function of separating a security domain between the infrastructured network connection and the Wi-Fi Direct connection, and a cross connection function to share an Internet connection may be provided by the Wi-Fi Direct technology.

In addition, since the Wi-Fi Direct technology is based on the conventional WLAN technology, that is, IEEE 802.11, the Wi-Fi Direct devices may be compatible with conventional legacy WLAN devices.

Hereinafter, a method of activating Wi-Fi Direct, a method of performing image forming operations, a method of managing channels, and a method of changing a WLAN mode in an MFP supporting Wi-Fi Direct will be described in detail with reference to the accompanying drawings.

As illustrated in the description with reference to FIG. 7, the MFP supporting Wi-Fi Direct supports the concurrent connection function, that is, may be connected to the infrastructured network and P2P connected to a wireless terminal supporting Wi-Fi Direct. The concurrent connection function is very useful in a situation where the MFP is connected to an AP of the infrastructured network and at the same time, a print operation has to be performed by using wireless devices that are not connected to the AP. The wireless devices that are not connected to the AP may be connected to the MFP by using an ad-hoc function in order to use a wireless printing service; however, if one MFP is connected to the infrastructured network, the MFP may not simultaneously use the ad-hoc function.

Detailed operation methods of performing image forming operations, such as a printing or scanning operation, by using the wireless devices that are P2P connected to the MFP via Wi-Fi Direct when the MFP uses the concurrent connection function, managing channels used to connect to the infrastructured network and to connect the Wi-Fi Direct, and changing an operation mode between the Wi-Fi Direct mode and the ad-hoc operation mode are to be provided.

First, a method of activating Wi-Fi Direct so that the MFP supporting Wi-Fi Direct functions as an AGO will be described below.

FIG. 10 is a block diagram illustrating a software program configuration of an MFP supporting Wi-Fi Direct according to an embodiment of the present invention. FIG. 10 illustrates an AGO 1012b included in a Wi-Fi Direct connection manager 1012a to make the MFP supporting Wi-Fi Direct perform as an AGO. Also, a GO SSID and PSK generation module 1007a included in a Wi-Fi Direct library 1007 generates an SSID and a PSK that are necessary when the MFP functions as the AGO.

FIG. 10 also illustrates similar features to those of FIG. 9. For example, a WLAN dongle firmware 1001 is firmware for connecting the WLAN, and may be stored in WLAN dongle hardware or may be transmitted to the WLAN dongle hardware from a main board of the MFP when booting the MFP. A bus driver 9102 and a STA (station) host driver 1003 are low level bus drivers for communicating with the WLAN hardware. A WLAN controlling channel 1004 and a WLAN data channel 1005 are channels for communicating with the WLAN firmware. A Wi-Fi Direct module 1007 performs the Wi-Fi Direct connection and transmits an operating command to the WLAN firmware. An IEEE 802.11u generic advertisement service (GAS) module 1008 performs functions according to IEEE 802.11u GAS, a module 1009 performs functions relating to CxAPI, and a WPS module 1010 performs a WPS function. A soft AP module 1011 is a software module allowing the MFP to perform as the AP. A transmission control protocol (TCP)/IP 1013 is a standard protocol for network transmission. A Wi-Fi Direct connection manager 1012 is a module for controlling the Wi-Fi Direct connection. A Wi-Fi Direct user interface 1015 allows the user to perform settings related to the Wi-Fi Direct, and may be included in a user interface 1014 that is installed in an embedded web server (EWS). A DHCP server 1016 automatically allocates an IP to the Wi-Fi Direct device that is connected as a client. A network application program 1017 performs various application operations relating to the network.

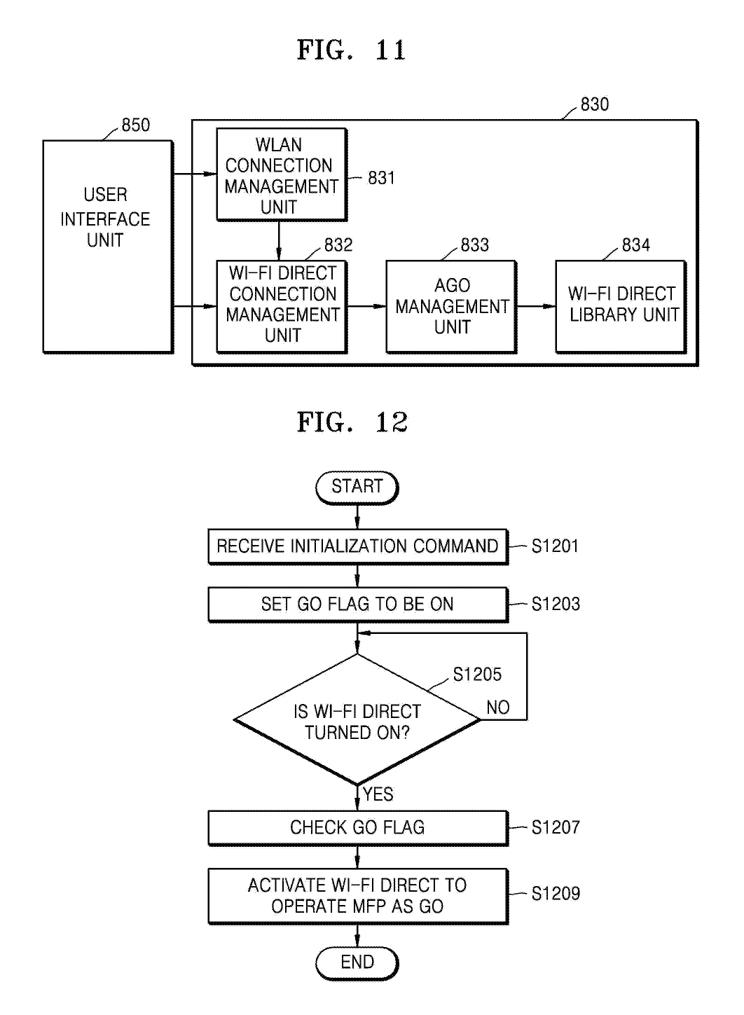

FIG. 11 is a detailed block diagram illustrating an MFP supporting Wi-Fi Direct according to the embodiment of the present general inventive concept. FIG. 11 illustrates a basic structure of the MFP supporting Wi-Fi Direct. The CPU 830 of FIG. 8 includes a WLAN connection manager 831, a Wi-Fi Direct connection manager 832, an AGO manager 833, and a Wi-Fi Direct library unit 834. The Wi-Fi Direct connection manager 832 receives a Wi-Fi Direct initialization command from the WLAN connection manager 831 from a user via the user interface module 850, and then, the Wi-Fi Direct connection manager 832 turns a GO flag on. The AGO manager 833 identifies the GO flag, and when the GO flag is in a turned on state, the AGO manager 833 activates Wi-Fi Direct so that the MFP performs as a GO. The Wi-Fi Direct library unit 834 generates an SSID and a PSK of the GO according to a command of the AGO manager 833.

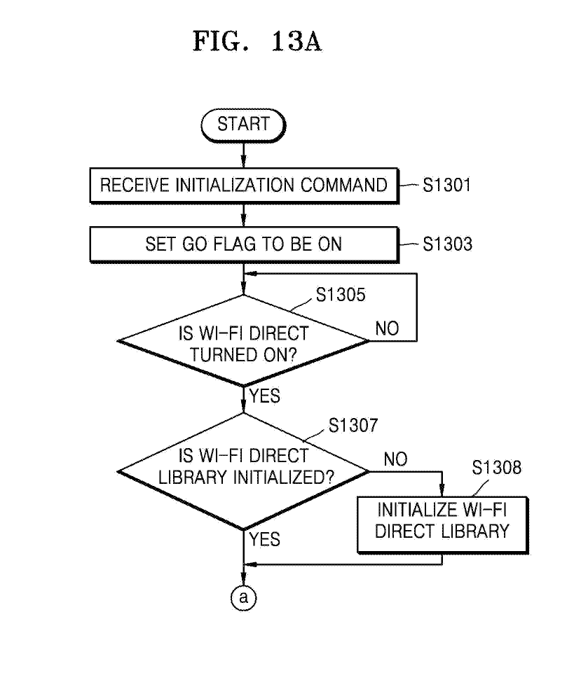

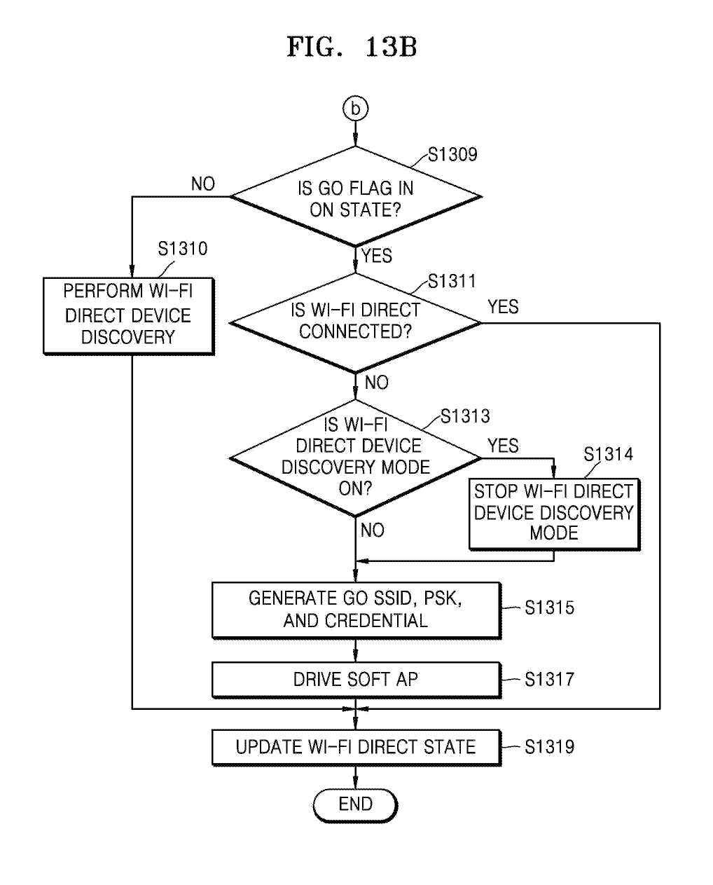

FIGS. 12, 13A, and 13B are flowcharts illustrating a method of activating Wi-Fi Direct in an MFP supporting Wi-Fi Direct, according to an embodiment of the present general inventive concept. Hereinafter, the method of activating Wi-Fi Direct will be described in detail with reference to FIGS. 11 through 13.

Referring to FIG. 12, an initialization command is received at operation S1201. The initialization command is a Wi-Fi Direct initialization command, and may be an MFP initialization command that is accompanied with the initialization of Wi-Fi Direct. The initialization command may be directly input by the user via the user interface module 850, or may be transmitted from the WLAN connection manager 831. When the initialization command is received, the Wi-Fi Direct connection manager 832 turns the GO flag on at operation S1203. The GO flag is an index representing whether Wi-Fi Direct is activated so that the MFP becomes the GO. When the GO flag is in a turned on state, the MFP functions as the GO, and when the GO flag is in a turned off state, the MFP does not function as the GO. In the present embodiment, the GO flag is automatically turned on when the initialization command is received, and thus, the MFP may perform as the AGO without connecting to the other Wi-Fi Direct devices. In addition, it is determined whether Wi-Fi Direct is turned on at operation S1205. If Wi-Fi Direct is turned on, the process goes to operation S1207 in which the AGO manager 833 identifies the GO flag. If the GO flag is in a turned on state, the process goes to operation S1209 in which Wi-Fi Direct is activated so that the MFP becomes the GO. However, when determining whether Wi-Fi Direct is in a turned on state in operation S1205, the turned on state of Wi-Fi Direct denotes that the MFP is set to use the Wi-Fi Direct function.

Referring to FIG. 13A, when an initialization command at operation S1301 is received, the GO flag is turned on at operation S1303, and it is determined whether Wi-Fi Direct is in a turned on state at operation S1305. The above processes are the same as the operations described with reference to FIG. 12. When it is determined that Wi-Fi Direct is in a turned on state in operation S1305, the Wi-Fi Direct connection manager 832 determines whether the Wi-Fi Direct library is initialized. If it is determined that the Wi-Fi Direct library is initialized, the process goes to operation S1309 of FIG. 13B in which the AGO manager 833 determines whether the GO flag is in a turned on state. Otherwise, if it is determined that the Wi-Fi Direct library is not initialized, the Wi-Fi Direct library is initialized in operation S1308, and then, the process goes to operation S1309. If the GO flag is determined to be in the turned on state in operation S1309, it is determined whether Wi-Fi Direct is connected at operation S1311. Otherwise, if the GO flag is in the turned off state, a Wi-Fi Direct device discovery process is performed at operation S1310, and then, the process goes to operation S1319 to update the state of Wi-Fi Direct. If it is determined that Wi-Fi Direct is connected in operation S1311, the Wi-Fi Direct state is also updated in operation S1319. Otherwise, if it is determined that Wi-Fi Direct is not connected in operation S1311, it is determined whether the Wi-Fi Direct device discovery mode is operating at operation S1313. If the device discovery mode is not operating, the process goes directly to operation S1315; however, if the device discovery mode is operating, the Wi-Fi Direct device discovery mode is terminated at operation S1414, and the process goes to operation S1315. An SSID, a PSK, and a GO credential that are necessary when the MFP operates as the GO are generated at operation S1315, and then, a soft AP is driven to activate Wi-Fi Direct so that the MFP operates as the GO at operation S1317, and the Wi-Fi Direct state is updated at operation S1319.

As described above, when activating Wi-Fi Direct according to the Wi-Fi Direct initialization command, the MFP may operates as the AGO even when the MFP is not connected to other Wi-Fi Direct devices, and thus, the Wi-Fi Direct network is formed in advance to be connected to legacy wireless devices that do not support Wi-Fi Direct. In addition, the MFP may perform as a GO having relatively higher power consumption due to an advantage that the MFP may consume a lot of electric power as a fixed device, that is a stationary device to receive a power to operate with the received power and also to be able to supply the power to an external device through a wired or wireless transmission method. Also, an IP address of the MFP may be fixed.

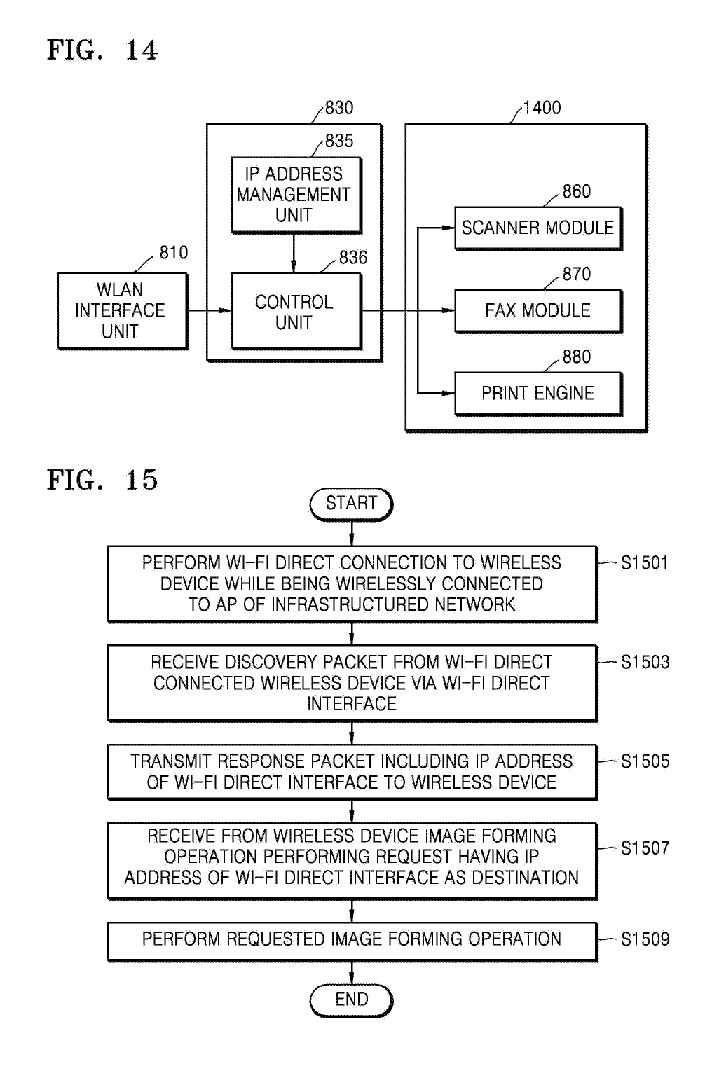

Hereinafter, a method of performing image forming processes in an MFP supporting Wi-Fi Direct will be described with reference to the accompanying drawings. FIG. 14 is a detailed block diagram illustrating an MFP supporting Wi-Fi Direct according to an embodiment of the present general inventive concept. FIG. 8 illustrates a basic structure of the MFP supporting Wi-Fi direct. The CPU 830 of FIG. 8 may include an IP address manager 835 and a controller 836. In addition, the scanner module 860, the fax module 870, and the print engine 880 are included in an image forming unit 1400.

The WLAN interface unit 810 allows the MFP to be Wi-Fi Direct connected at the same time of being connected to the infrastructured network. The IP address manager 835 manages an IP address of the infrastructured network and an IP address of the Wi-Fi Direct interface. The MFP supports the concurrent connection function as described above, and may have two different IP addresses according to the interfaces in the case where the MFP is connected to both of the infrastructured network and the Wi-Fi Direct. The IP address manager 835 identifies the IP address of each interface and provides the controller 836 with the IP address. The controller 836 receives the IP addresses from the IP address manager 835 and controls execution of the image forming operation requested by an external wireless device. In more detail, when the controller 836 receives a discovery packet from the wireless terminal Wi-Fi Direct connected to the MFP through the Wi-Fi Direct interface, the controller 836 receives the IP address of the Wi-Fi Direct interface from the IP address manager 835 to generate a response packet including the IP address and transmit the response packet to the wireless terminal. The wireless terminal analyzes the response packet transmitted from the MFP to get the IP address of the Wi-Fi Direct interface of the MFP. Also, the controller 836 may generate the response packet further including information on services available by the MFP, and in this case, the wireless terminal may determine the services that may be provided by the MFP by analyzing the response packet.

If the controller 836 receives a request to perform an image forming operation the request being transmitted to the destination of which is the IP address of the Wi-Fi Direct interface, from the wireless terminal Wi-Fi Direct connected to the MFP, the controller 836 may allow the image forming unit 1400 to perform the requested image forming operation. For example, if the controller 836 receives print data using the destination of which is the IP address of the Wi-Fi Direct interface, from the wireless terminal, the controller 836 allows the print engine 880 to perform a print operation according to the received print data. When the controller 836 receives a scan request through the destination of which is the IP address of the Wi-Fi Direct interface, from the wireless terminal, and allows the scanner module 860 to perform the scanning operation.

FIG. 15 is a flowchart illustrating a method of performing an image forming operation of the MFP supporting Wi-Fi Direct, according to an embodiment of the present general inventive concept. Referring to FIG. 15, the MFP is Wi-Fi Direct connected to the wireless terminal in a state of being connected to the AP of the infrastructured network by using the concurrent connection function at operation S1501. The MFP receives a discovery packet from the wireless terminal that is Wi-Fi Direct connected to the MFP via the Wi-Fi Direct interface at operation S1503. When the discovery packet from the wireless terminal is received via the Wi-Fi Direct interface, the MFP generates a response packet including an IP address of the Wi-Fi Direct interface and transmits the response packet to the wireless terminal at operation S1505. The wireless terminal receiving the response packet may identify the IP address of the Wi-Fi Direct interface of the MFP by analyzing the response packet. Further, the MFP may generate a response packet including information about available services of the MFP, and in this case, the wireless terminal may identify the kinds of image forming operation services provided by the MFP by analyzing the response packet. When the wireless terminal receiving the response packet transmits a request for executing the image forming operation to a destination of the IP address of the Wi-Fi Direct interface, the MFP receives the response packet at operation S1507, and performs the requested image forming operation at operation S1509. For example, when print data, the destination of which is the IP address of the Wi-Fi Direct interface, is received in operation S1507, the printing is performed according to the print data at operation S1509, and if a scanning request, the destination of which is the IP address of the Wi-Fi Direct interface, is received in operation S1507, the scanning operation is performed at operation S1509.

As described above, the response packet, including the IP address of the Wi-Fi Direct interface, is transmitted to the wireless terminal that is Wi-Fi Direct connected to the MFP, and when the MFP receives the request to perform the image forming operation, the destination of which is the IP address of the Wi-Fi Direct interface, from the wireless terminal, the MFP performs the request. Thus, the MFP may stably perform the image forming operation requested by the wireless terminal that is Wi-Fi Direct connected to the MFP in a state of being connected to the infrastructured network and the Wi-Fi Direct simultaneously.

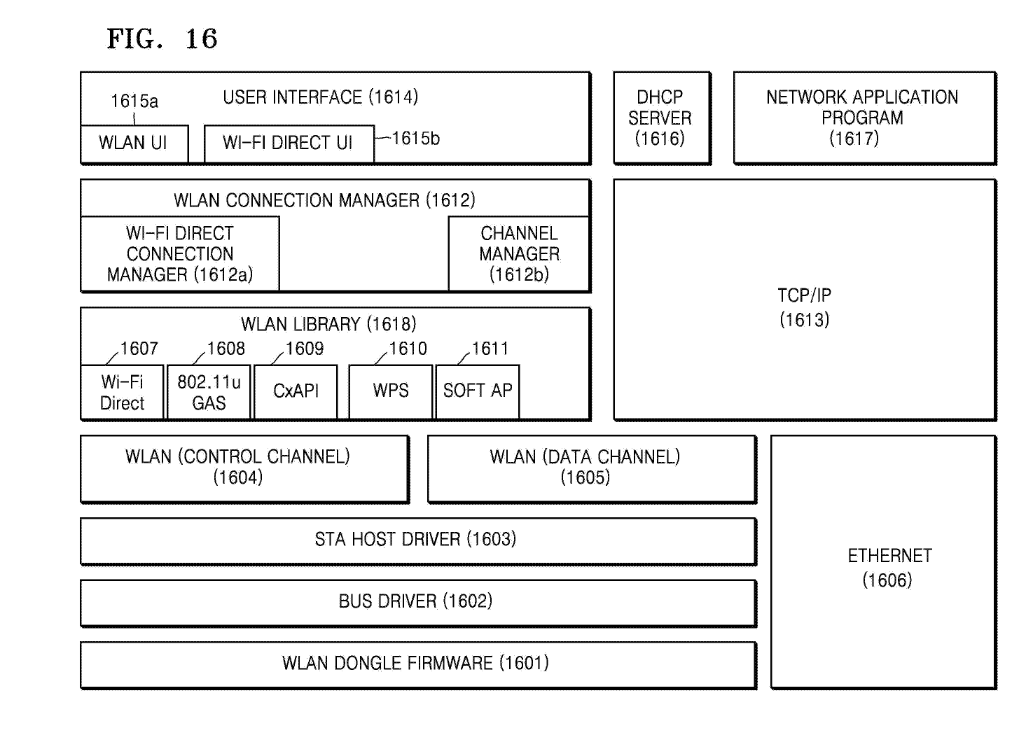

Hereinafter, a method of managing channels in the MFP supporting Wi-Fi Direct will be described in detail with reference to the accompanying drawings. FIG. 16 is a block diagram illustrating a software program configuration of the MFP supporting Wi-Fi Direct according to the embodiment of the present general inventive concept. FIG. 16 illustrates a channel manager 1612b included in a WLAN connection manager 1612 to manage a channel used by the MFP to connect to the infrastructured network AP and a Wi-Fi Direct operation channel used in the Wi-Fi Direct connection.

FIG. 16 also illustrates the similar features to those of FIG. 9. For example, a WLAN dongle firmware 1601 is firmware for connecting the WLAN, and may be stored in WLAN dongle hardware or may be transmitted to the WLAN dongle hardware from a main board of the MFP when booting the MFP. A bus driver 1602 and a STA (station) host driver 1603 are low level bus drivers for communicating with the WLAN hardware. A WLAN controlling channel 1604 and a WLAN data channel 1605 are channels for communicating with the WLAN firmware. A Wi-Fi Direct module 1607 performs the Wi-Fi Direct connection and transmits an operating command to the WLAN firmware. An IEEE 802.11u generic advertisement service (GAS) module 1608 performs functions according to IEEE 802.11u GAS, a module 1609 performs functions relating to CxAPI, and a WPS module 1610 performs a WPS function. A soft AP module 1611 is a software module allowing the MFP to perform as the AP. A transmission control protocol (TCP)/IP 1613 is a standard protocol for network transmission. A Wi-Fi Direct connection manager 1612 is a module for controlling the Wi-Fi Direct connection. A Wi-Fi Direct user interface 1615 allows the user to perform settings related to the Wi-Fi Direct, and may be included in a user interface 1614 that is installed in an embedded web server (EWS). A DHCP server 1616 automatically allocates an IP to the Wi-Fi Direct device that is connected as a client. A network application program 1617 performs various application operations relating to the network.

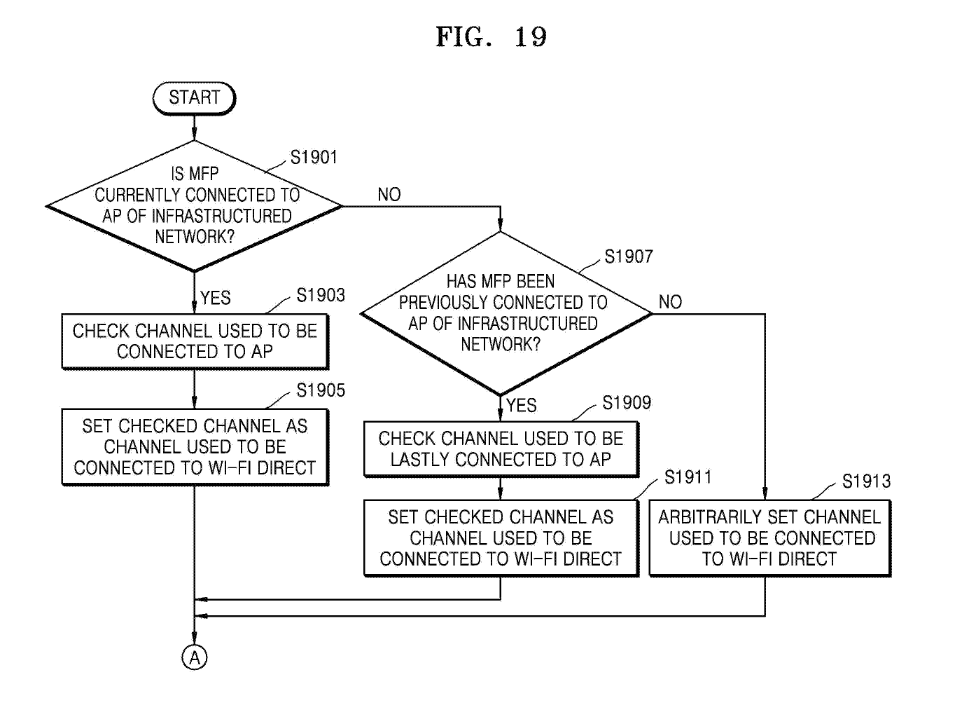

The method of managing the channels used in the connections by the channel manager 1612b will be described below with reference to FIGS. 18 through 24.

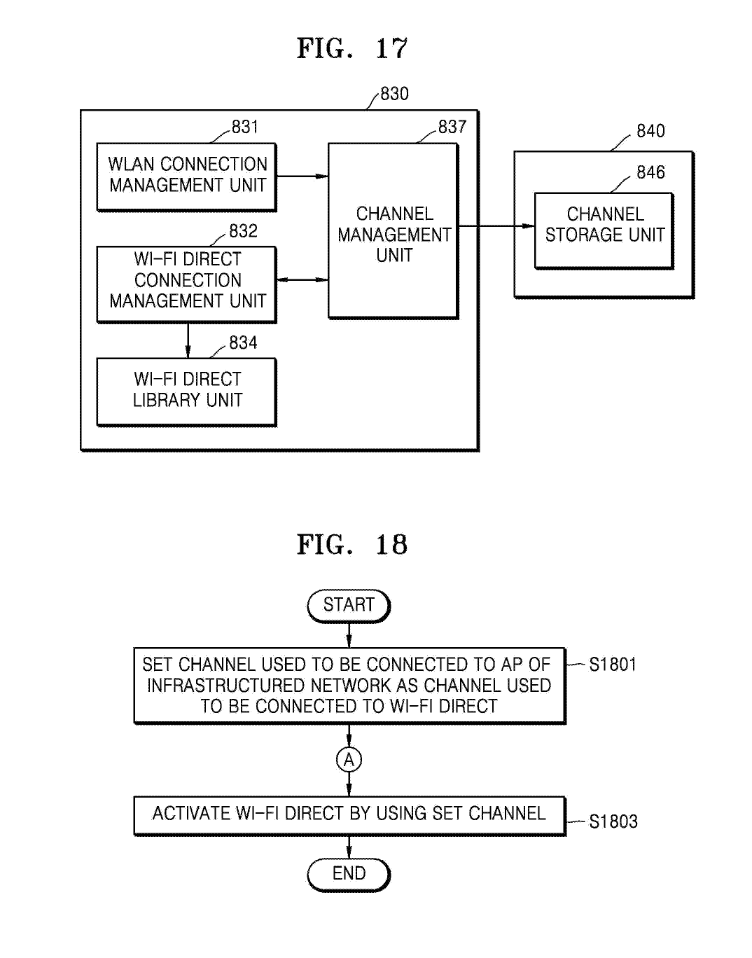

FIG. 17 is a block diagram illustrating the MFP supporting Wi-Fi Direct according to the embodiment of the present general inventive concept. Referring back to FIG. 8 illustrating a basic configuration of the MFP supporting Wi-Fi Direct, the CPU 830 may include a WLAN connection manager 831, a Wi-Fi Direct connection manager 832, a Wi-Fi Direct library unit 834, and a channel manager 837. Also, the memory unit 840 may include a channel storage unit 846 therein. The channel manager 837 identifies the channel used by the MFP to connect to the infrastructured network AP from the WLAN connection manager 831, and identifies the Wi-Fi Direct operation channel used in the Wi-Fi Direct connection from the Wi-Fi Direct connection manager 832. In addition, the channel manager 837 makes the channel used in the AP connection and the Wi-Fi Direct operation channel coincide with each other. Also, the channel manager 837 stores the channel used in the connection to the infrastructured network AP in the channel storage unit 846 so that the stored channel may be set as the Wi-Fi Direct operation channel when the connection to the infrastructured network AP is disconnected and Wi-Fi Direct is activated. Since the MFP is mainly used as a fixed device, it is likely to use the channel that has been used to connect to the infrastructured network AP once again. When the Wi-Fi Direct operation channel is set to be the same as the channel used to connect to the AP by the channel manager 837, the Wi-Fi Direct connection manager 832 activates Wi-Fi Direct through the set Wi-Fi Direct operation channel by using the Wi-Fi Direct library unit 834.

FIGS. 18 through 23 are flowcharts illustrating the method of managing the channels in the MFP supporting Wi-Fi Direct according to the embodiment of the present general inventive concept. Hereinafter, the channel managing method will be described in detail below with reference to FIGS. 18 through 23.

Referring to FIG. 18, a channel that has been used to connect the MFP to the infrastructured network AP is set as the Wi-Fi Direct operation channel at operation S1801, and Wi-Fi Direct is activated by using the set channel at operation S1803. Here, sub-processes of operation S1801 of setting the channel used in the connection to the AP as the Wi-Fi Direct operation channel are illustrated in FIG. 19. Referring to FIG. 19, before activating Wi-Fi Direct, it is determined whether the MFP is connected currently to the infrastructured network AP at operation S1901. As a result of determination, if the MFP is currently connected to the infrastructured network AP, the channel used in the connection to the AP is identified at operation S1903. In addition, the identified channel is set as the Wi-Fi Direct operation channel at operation S1905. However, as a result of the determination in operation S1901, if the MFP is not currently connected to the infrastructured network AP, it is determined whether the MFP has ever been connected to the infrastructured network AP at operation S1907. If the MFP has been connected to the infrastructured network AP, the channel used in the last connection to the AP is identified at operation S1909, and the identified channel is set as the Wi-Fi Direct operation channel at operation S1911. On the other hand, if the MFP has never been connected to the infrastructured network AP before in operation S1907, an arbitrary channel is set as the Wi-Fi Direct operation channel at operation S1913.

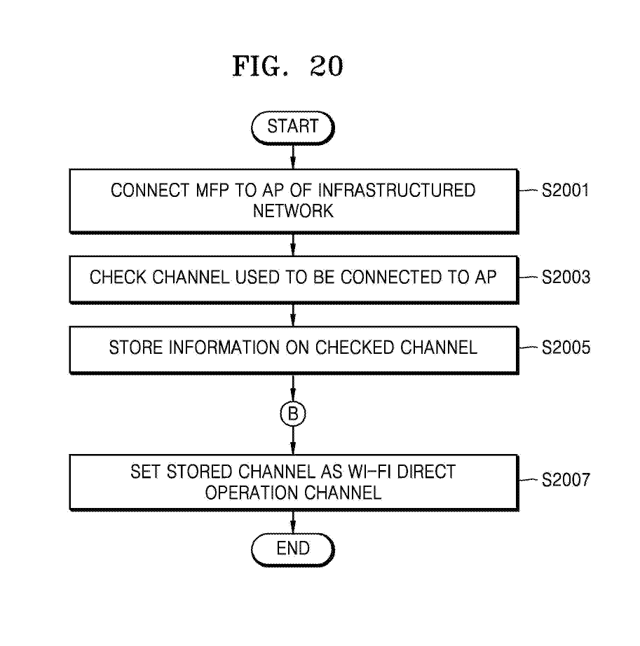

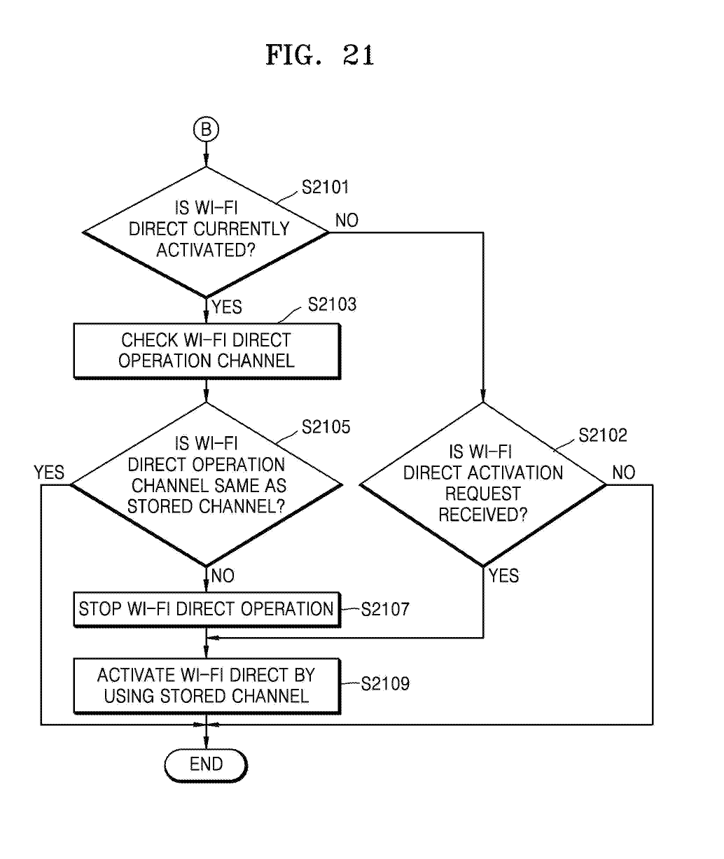

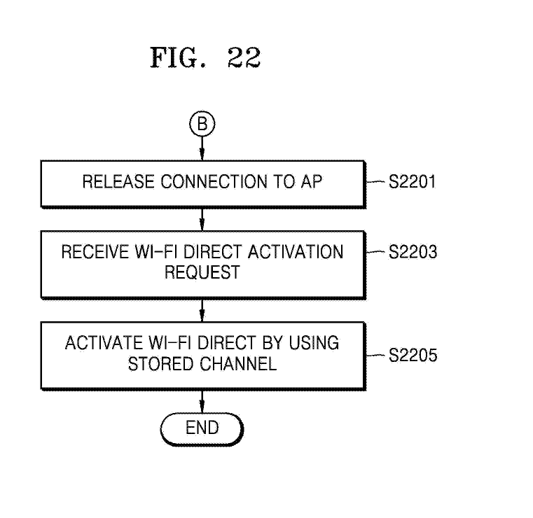

FIGS. 20 through 22 are flowcharts illustrating processes of setting the Wi-Fi Direct operation channel in a state where the MFP is connected to the AP of the infrastructured network. Referring to FIG. 20, the MFP is connected to the infrastructured network AP at operation S2001, and the channel used in the connection to the AP is identified at operation S2003. The channel identified in operation S2003 is stored at operation S2005, and the stored channel is set as the Wi-Fi Direct operation channel at operation S2007. Here, sub-processes of operation S2007 for setting the stored channel as the Wi-Fi Direct operation channel are illustrated in FIGS. 21 and 22.

Referring to FIG. 21, after storing the channel identified in operation S2005 of FIG. 20, it is determined whether Wi-Fi Direct is currently activated at operation S2101. As a result of determination, if Wi-Fi Direct is currently activated, the Wi-Fi Direct operation channel is identified at operation S2103. In addition, it is determined whether the Wi-Fi Direct operation channel coincides with the stored channel at operation S2105, and if it is determined that the two channels are not the same as each other, the Wi-Fi Direct operation is stopped at operation S2107, and the stored channel is set as the Wi-Fi Direct operation channel to activate Wi-Fi Direct at operation S2109. Otherwise, if it is determined that the Wi-Fi Direct is not currently activated in operation S2101, it is identified whether there is a request for activating Wi-Fi Direct at operation S2102, and if there is a request, the stored channel is set as the Wi-Fi Direct operation channel to activate Wi-Fi Direct at operation S2109.

As another example of the sub-processes of operation S2007 of FIG. 20, referring to FIG. 22, after storing the channel identified in operation S2005 illustrated in FIG. 20, the connection between the MFP and the infrastructured network AP is disconnected at operation S2201. In addition, when the MFP receives a Wi-Fi Direct activation request at operation S2203, the stored channel is set as the Wi-Fi Direct operation channel to activate Wi-Fi Direct at operation S2205.

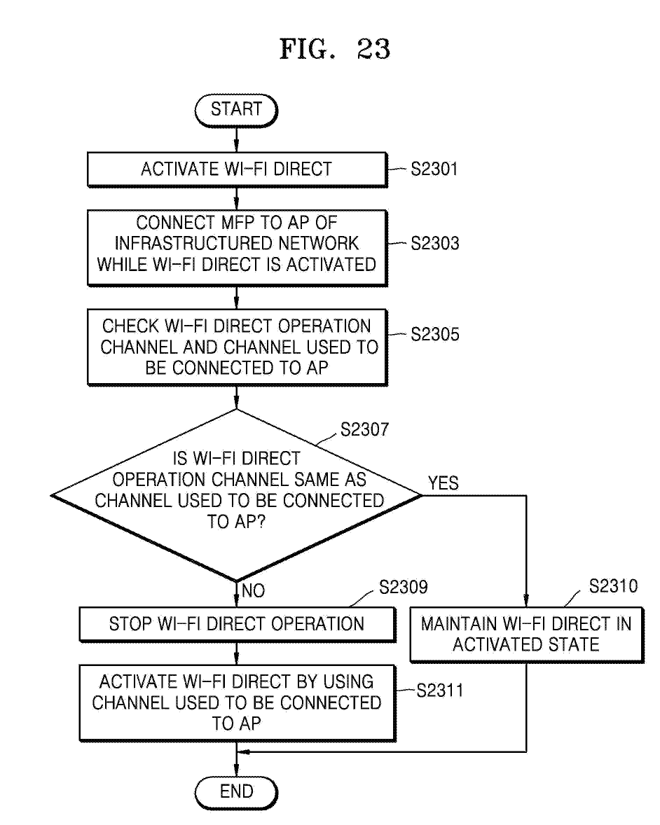

FIG. 23 is a flowchart illustrating processes of setting the Wi-Fi Direct operation channel in a state where Wi-Fi Direct of the MFP is activated. Referring to FIG. 23, Wi-Fi Direct of the MFP is activated at operation S2301, and the MFP is connected to the infrastructured network AP in a state where Wi-Fi Direct is activated at operation S2303. The Wi-Fi Direct operation channel and the channel used in the connection to the AP are identified at operation S2305. It is determined whether the Wi-Fi Direct operation channel is the same as the channel used in the connection to the AP at operation S2307, and if it is determined that the two channels are not the same as each other, the Wi-Fi Direct operation is stopped at operation S2309, and the channel used in the connection to the AP is set as the Wi-Fi Direction operation channel to activate Wi-Fi Direct at operation S2311.

The above processes will be described in detail with reference to FIG. 16 below. If the MFP is connected to the AP operating in channel 6 at 2.4 GHz when the Wi-Fi Direct operation channel is channel 1 at 2.4 GHz, the channel manager 1612b reads out the channel of the connected AP via the WLAN library 1618 from a wireless module and notifies the Wi-Fi Direct manager 1612a of the read channel so that the Wi-Fi Direct operation channel is changed to the channel 6. The Wi-Fi Direct manager 1612a performs a preliminary operation of changing the channel, such as termination of the soft AP, change of an information element, and termination of a device discovery operation, and then, changes the Wi-Fi Direct operation channel to the channel 6 to activate Wi-Fi Direct.

In general, since a wireless MFP performs transmission via one wireless antenna, the wireless MFP has to communicate by using one communication channel at once. Therefore, when a concurrent connection function, in which the MFP is simultaneously connected to the infrastructured network and the Wi-Fi Direct, is performed, there may be a problem in using the communication function. If two different channels are used in the connection to the infrastructured network and the Wi-Fi Direct connection, a wireless chipset of superior CPU performance may process all of the packets while continuously reciprocating two channels in a time-division manner; however, services of each of the channels may be delayed and stability of the channels may be degraded. However, according to the method of managing the channels of the present embodiment, a single channel is used in the concurrent connection, and thus, the above problems may be addressed. Also, the channel of the infrastructured network AP is not known to the MFP before the MFP is connected to the AP; however, according to the present embodiment, even when the MFP is connected to the infrastructured network AP in a state where Wi-Fi Direct is activated first, the channel information of the AP is read and the Wi-Fi Direct operation channel is set according to the AP channel information so as to use a single channel.

Hereinafter, a method of changing an operation mode in the MFP supporting Wi-Fi Direct will be described below with reference to the accompanying drawings. There may be two WLAN usage modes of the MFP, that is, an ad-hoc mode and an infrastructured network mode. The ad-hoc mode is a mode in which the MFP is wirelessly connected to the wireless device by using ad-hoc communication, and the infrastructured network mode is a mode in which the MFP is wirelessly connected to the infrastructured network AP.

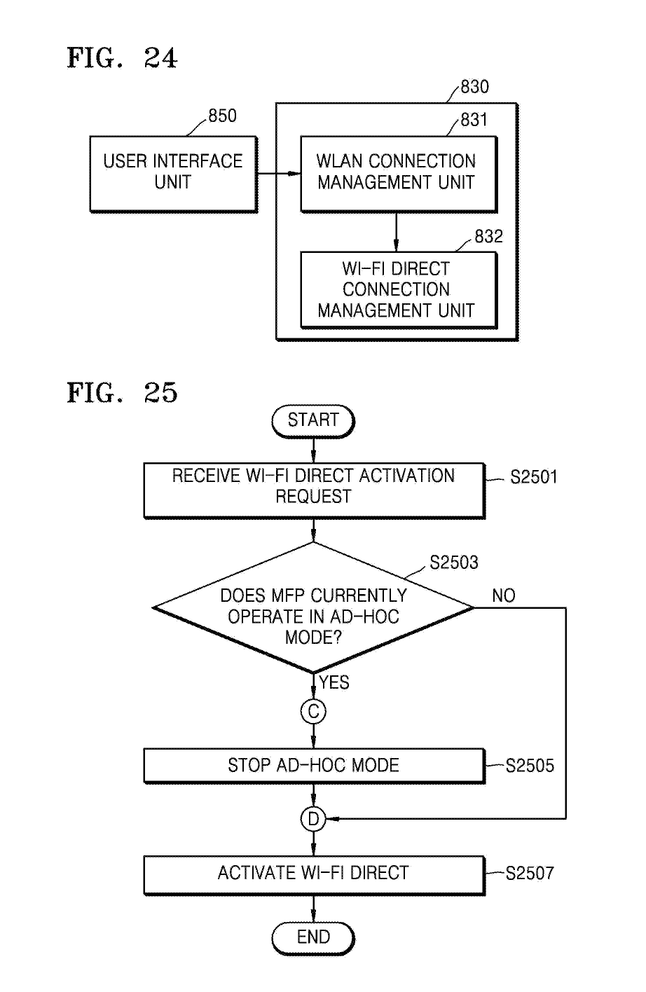

FIG. 24 is a block diagram illustrating the MFP supporting Wi-Fi Direct according to the embodiment of the present general inventive concept. FIG. 8 illustrates a basic configuration of the MFP supporting Wi-Fi Direct. Referring to FIGS. 8 and 24, the CPU 830 may include the WLAN connection manager 831 and the Wi-Fi Direct connection manager 832. Detailed operations of each of the components will be described below with reference to FIGS. 25 through 27.

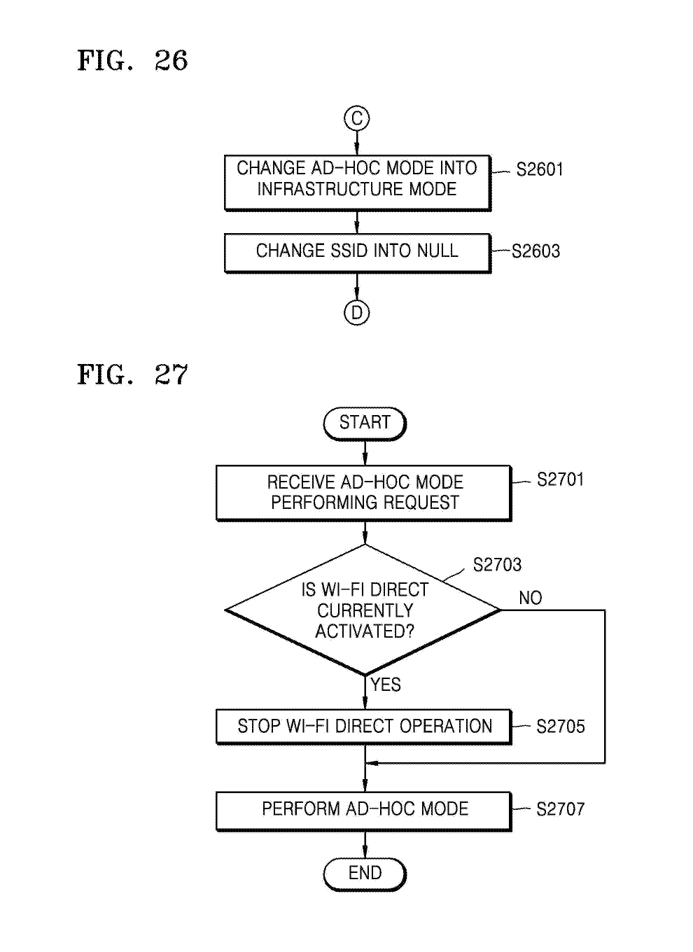

FIGS. 25 through 27 are flowchart illustrating a method of changing the operation mode of the MFP supporting Wi-Fi Direct, according to the embodiment of the present general inventive concept. Referring to FIG. 25, when a Wi-Fi Direct activation request is transmitted from a user via the user interface module 850 at operation S2501, the WLAN connection manager 831 determines whether the MFP currently operates in the ad-hoc mode at operation S2503. If it is determined that the MFP currently operates in the ad-hoc mode, the WLAN connection manager 831 terminates the ad-hoc mode and requests the Wi-Fi Direct connection manager 832 to activate Wi-Fi Direct at operation S2505. The Wi-Fi Direct connection manager 832 activates Wi-Fi Direct according to the request at operation S2507. Here, sub-processes of operation S2505 in which the WLAN connection manager 831 terminates the ad-hoc mode are illustrated in FIG. 26. Referring to FIG. 26, the WLAN connection manager 831 may change the operation mode of the MFP from the ad-hoc mode to the infrastructured network mode at operation S2601. Here, the WLAN connection manager 831 may only terminate the ad-hoc mode without changing the operation mode to the infrastructured network mode. The SSID of the MFP, which is set for executing the ad-hoc mode, may be changed to a null state in order to terminate the ad-hoc mode at operation S2603.

Referring to FIG. 27, when an ad-hoc mode execution request is received via the user interface module 850 at operation S2701, the WLAN connection manager 831 determines whether Wi-Fi Direct of the MFP is currently activated at operation S2703. As a result of the determination, if the Wi-Fi Direct of the MFP is currently activated, the WLAN connection manager 831 requests the Wi-Fi Direct connection manager 832 to terminate the Wi-Fi Direct operation. Accordingly, when the Wi-Fi Direct connection manager 832 terminates the Wi-Fi Direct operation at operation S2705, the WLAN connection manager 831 executes the ad-hoc mode at operation S2707.

Although the Wi-Fi Direct technology supports the concurrent connection function to the infrastructured network and the Wi-Fi Direct, there may be a limitation, that is, the MFP may not be connected to the Wi-Fi Direct while operating in the ad-hoc mode. The ad-hoc mode may ensure mutual compatibility between devices under IEEE 802.11b; however, Wi-Fi Direct does not support IEEE 802.11b. Therefore, when there is a request to execute the Wi-Fi Direct mode or the ad-hoc mode while operating in the ad-hoc mode or the Wi-Fi Direct mode, a method of selectively changing the operation mode is necessary, as provided in the embodiments of the present general inventive concept.

According to the present general inventive concept, when activating Wi-Fi Direct according to the initialization command, the MFP may operate as a GO even if the MFP is not connected to other Wi-Fi Direct devices in order to form the Wi-Fi Direct network in advance, so that the MFP may provide connections to legacy wireless terminals that do not support Wi-Fi Direct. Also, the MFP that is a fixed type device may perform as the GO that has a relatively large power consumption.

Also, when the Wi-Fi Direct activation request is received while operating in the ad-hoc mode, the ad-hoc mode is terminated and Wi-Fi Direct is activated, and accordingly, a problem that the Wi-Fi Direct connection is not possible while operating in the ad-hoc mode may be addressed.

In the descriptions of a method of registering use of a mobile terminal supporting a near field communication (NFC) function to an image forming apparatus, the image forming apparatus using the method, a method of requesting registration of the use of the mobile terminal supporting the NFC function, and the mobile terminal using the method according to embodiments of the present disclosure, those aspects well-known to a person of ordinary skill in the art will not be described in detail.

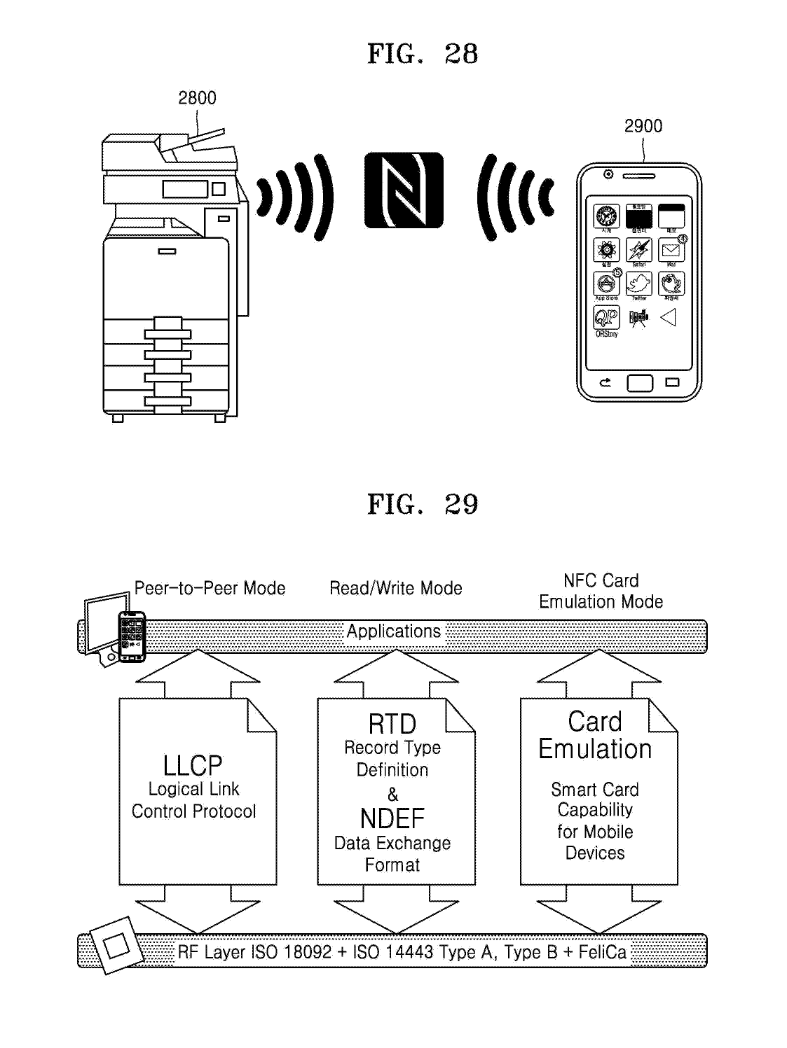

FIG. 28 illustrates an image forming apparatus 2800 and a mobile terminal 2900 that perform near field communication (NFC), according to an embodiment of the present disclosure.

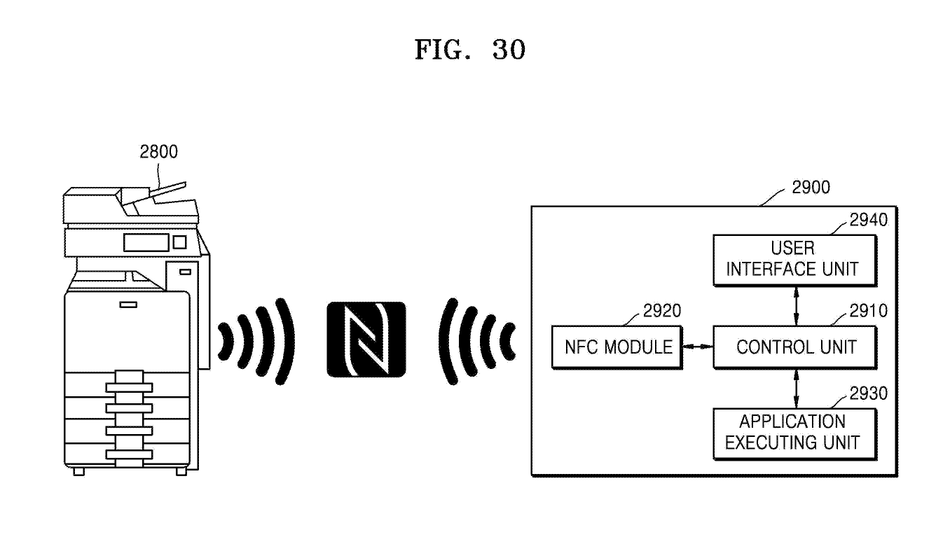

Referring to FIG. 28, the image forming apparatus 2800 and the mobile terminal 2900 that each support an NFC function are present. The image forming apparatus 2800 in which an NFC module, or NFC interface, is embedded in advance or in which an NFC module in the form of a chip is installed may perform NFC that uses the NFC module with the mobile terminal 2900 including the NFC module. NFC that uses the NFC module may be performed by using one of three communication modes, descriptions of which will now be provided with reference to FIG. 29.

FIG. 29 is a diagram illustrating three communication modes of NFC.

Referring to FIG. 29, the three communication modes of NFC may include a peer-to-peer (P2P) mode, a read/write mode, and an NFC card emulation mode.

In the P2P mode, communication at a link level between two NFC terminals, for example, between the image forming apparatus 2800 and the mobile terminal 2900, is supported. To establish a connection, a client (NFC P2P initiator, i.e., the mobile terminal 2900) searches for a host (NFC P2P target, i.e., the image forming apparatus 2800) and transmits data in an NFC Data Exchange Format (NDEF) message format. In the P2P mode, information such as emails, schedules, telephone numbers, and extensible markup language (XML) data, for example, may be exchanged by NFC tagging the mobile terminal 2900 to the image forming apparatus 2800.

The read/write mode supports a device, in which an NFC module is embedded, to operate as a reader for reading a tag of an NFC module of another device or to operate as a writer for inputting information to the tag of the NFC module of the other device.

Finally, in the NFC card emulation mode, a mobile device in which an NFC module is embedded operates as a smart card.

In order to provide the three communication modes of NFC, a protocol is standardized. A Logical Link Control Protocol (LLCP) is a protocol that sets a communication connection between layers and controls the same. An NDEF message is a basic message structure defined in an NFC communication protocol. The NDEF message includes one or more NDEF records. An NDEF record includes a payload that is described according to type, length, and option identifiers. An NDEF payload refers to application data included in an NDEF record. Record Type Definition (RTD) defines a record type and a type name which may correspond to the NDEF record.

The device including the NFC module may select one of the P2P mode, the read/write mode, and the NFC card emulation mode to set a communication mode using the NFC module, and thus NFC that uses the NFC may be performed. However, to perform NFC that uses the NFC module between devices including NFC modules, use of one device to another device should be registered during initial NFC.

Referring to FIG. 28, registering use of the mobile terminal 2900 to the image forming apparatus 2800 allows the image forming apparatus 2800 supporting the NFC function to perform NFC with the mobile terminal 2900 supporting the NFC function by NFC tagging. Such a process of registering a use of the mobile terminal 2900 may be performed only one time when an initial NFC is performed between two devices, and then is unnecessarily performed every time NFC is performed between two devices by NFC tagging. In spite of only the initial one time process of registering use thereof, users have problems in using NFC functions due to a complicated or difficult process. Embodiments relating to a process of registering the use of the mobile terminal 2900 supporting the NFC function to the image forming apparatus 2800 will be described below.

FIG. 30 is a diagram illustrating a structure of the mobile terminal 2900 supporting an NFC function, according to an embodiment of the present disclosure.

Referring to FIG. 30, the mobile terminal 2900 may include a control unit, or controller, 2910, an NFC module, or NFC interface, 2920, an application executing unit, or application executor, 2930, and a user interface (UI) unit, or UI, 2940. It will be understood by one of ordinary skill in the art that general-use components other than the components illustrated in FIG. 30 may also be included.

The control unit 2910 may control a general function of the mobile terminal 2900 and may be a microprocessor.

The control unit 2910 may transmit or receive data to or from an external device through the NFC module 2920. For example, when the mobile terminal 2900 is NFC tagged to the image forming apparatus 2800, the control unit 2910 may transmit or receive data to or from the image forming apparatus 2800 through NFC by NFC tagging. In particular, when the control unit 2910 initially performs NFC with the image forming apparatus 2800 by NFC tagging, the control unit 2910 may transmit data for registering use of the mobile terminal 2900 by using the NFC module 2920. In other words, the control unit 2910 may transmit use registration information including user information used to register use of the mobile terminal 2900 to the image forming apparatus 2800. The control unit 2910 may receive a result of the use registration of the mobile terminal 2900 from the image forming apparatus 2800 in response to transmission of the use registration information by using the NFC module 2920.

The control unit 2910 may control the application executing unit 2930 to execute various applications that may be executed in the mobile terminal 2900. For example, to obtain the use registration information used to register use of the mobile terminal 2900, the control unit 2910 may control the application executing unit 2930 to execute an application providing an interface used to input the use registration information.

The control unit 2910 may configure a UI screen to determine information input from a user through the UI unit 2940 or to output a processing result according to control of the control unit 2910 to the UI unit 2940. For example, when the application executing unit 2930 executes the application providing the interface used to input the use registration information, the control unit 2910 may determine user information input from the user through the UI unit 2940. The control unit 2910 may configure the UI screen to display the result of the use registration of the mobile terminal 2900 received from the image forming apparatus 2800 on the UI unit 2940 by using the NFC module 2920.

The NFC module 2920 may perform NFC with an external device such as the image forming apparatus 2800 by NFC tagging. When the mobile terminal 2900 approaches the external device such as the image forming apparatus 2800, the NFC module 2920 may perform NFC with an NFC module included in the external device such as the image forming apparatus 2800 by NFC tagging within a predetermined distance.

In particular, when the mobile terminal 2900 initially NFC tags the image forming apparatus 2800 within a predetermined distance, the NFC module 2920 may transmit the use registration information including the user information to the image forming apparatus 2800. The NFC module 2920 may receive the result of the use registration of the mobile terminal 2900 that is performed in the image forming apparatus 2800 from the image forming apparatus 2800 in response to transmission of the use registration information.

The application executing unit 2930 may execute a variety of applications that may be executed in the mobile terminal 2900. For example, the application executing unit 2930 may execute an application that inputs user information used to perform user authentication for registering use of the mobile terminal 2900 to the image forming apparatus 2800.

The UI unit 2940 may display information to the user and receive information from the user. The UI unit 2940 may include an input/output apparatus such as a capacitive or piezoelectric touch screen, a display panel, a touch pad, or a keyboard, for example, provided in the mobile terminal 2900. The UI unit 2940 may receive various inputs regarding use of the mobile terminal 2900 from the user. For example, the UI unit 2940 may receive the user information necessary for registering use of the mobile terminal 2900. The UI unit 2940 may display the result of the use registration of the mobile terminal 2900 to the user.

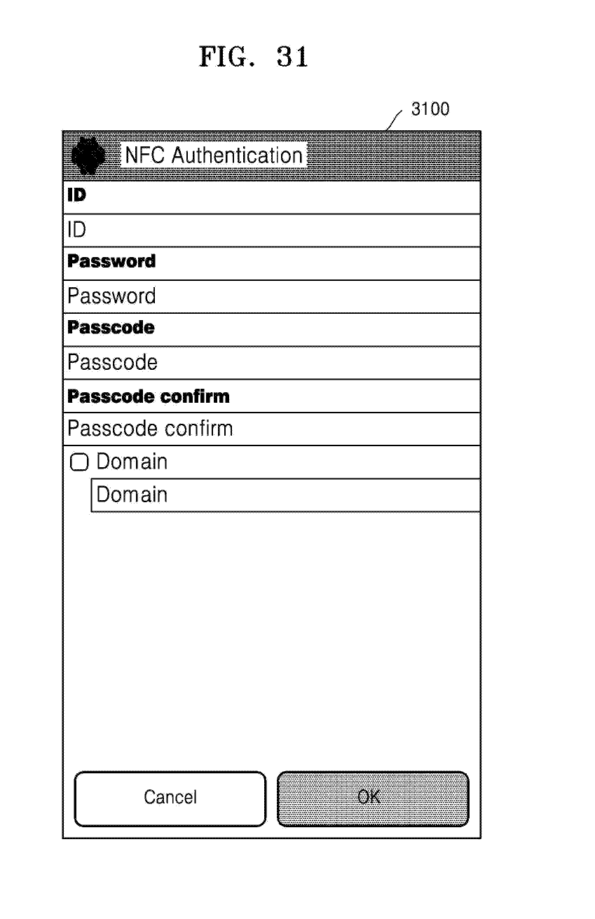

FIG. 31 is a diagram illustrating a result of the mobile terminal 2900 executing an application that inputs user information used to perform user authentication for registering use of the mobile terminal 2900 to the image forming apparatus 2800, according to an embodiment of the present disclosure.

When the mobile terminal 2900 supporting an NFC function initially performs NFC with the image forming apparatus 2800 by NFC tagging, the mobile terminal 2900 undergoes a process of registering use of the mobile terminal 2900 to the image forming apparatus 2800. To this end, the mobile terminal 2900 may transmit use registration information used to register use of the mobile terminal 2900 to the image forming apparatus 2800. To obtain the use registration information used to register use of the mobile terminal 2900, the mobile terminal 2900 may execute an application providing an interface to input the use registration information.

The use registration information used to register use of the mobile terminal 2900 may include the user information used to perform user authentication and device information used to identify the mobile terminal 2900. Referring to FIG. 31, the application providing the interface for inputting the user information may be executed to display an interface screen 3100 on the UI unit 2940 of the mobile terminal 2900. The user information used to perform user authentication for registering use of the mobile terminal 2900 may include an ID, a password, and a passcode, and may further include domain information as necessary.

A user may input user information in each region of the interface screen 3100 displayed on the UI unit 2940 of the mobile terminal 2900. If the user presses an OK button on the interface screen 3100 after inputting user information through the UI unit 2940, user information corresponding to each of the ID, the password, and the passcode may be encrypted by using specific encryption algorithm. In this regard, the application providing the interface for inputting the user information may further determine the device information used to identify the mobile terminal 2900 to encrypt the device information and the user information. In other words, the user information may be received from the user by displaying the interface screen 3100 for inputting the user information to the user, and the device information may not be received from the user but may be obtained by determining a stored value, and thus the use registration information including the user information and the device information may be encrypted before being transmitted to the image forming apparatus 2800.

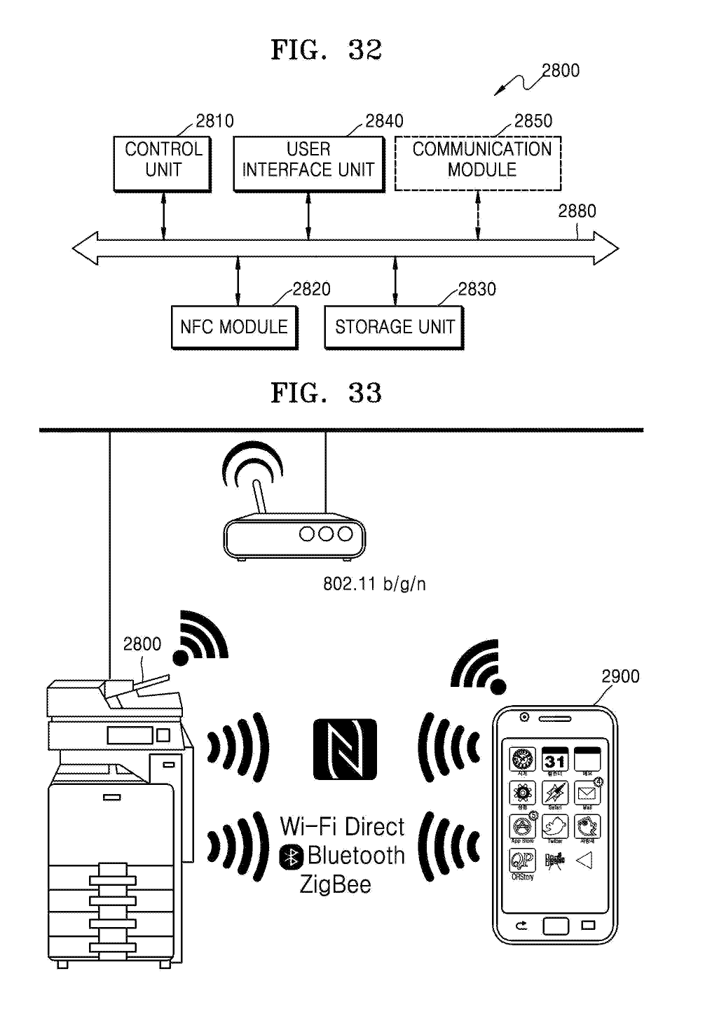

FIG. 32 illustrates a structure of the image forming apparatus 2800 according to an embodiment of the present disclosure.

Referring to FIG. 32, the image forming apparatus 2800 may include a control unit 2810, an NFC module 2820, a storage unit, or memory, 2830, and a user interface (UI) unit 2840. The image forming apparatus 2800 may further include a communication module, or interface, 2850 according to a method of performing user authentication. A data bus 180 is used to transmit or receive various types of data between the above components. It will be understood by one of ordinary skill in the art that general-use components other than the components illustrated in FIG. 32 may also be included. For example, the image forming apparatus 2800 may further include a facsimile machine that generates image data recorded in a document as facsimile data or processes the facsimile data from an external device, a scanner that scans the image data recorded in the document and generates scan data, and an image forming unit that forms an image and outputs copy and print data on a printing medium such as a print sheet, for example.

The control unit 2810 may control a general function of the image forming apparatus 2800 and may be a microprocessor. In this regard, the control unit 2810 may be classified into a plurality of processor modules separated according to functions and a main processor module that unites and manages the processor modules.

The control unit 2810 may receive or transmit data from or to the external device through the NFC module 2820. For example, when the mobile terminal 2900 is NFC tagged to the image forming apparatus 2800, the control unit 2810 may receive or transmit data from or to the mobile terminal 2900 through NFC by NFC tagging. In particular, when the control unit 2810 initially performs NFC with the mobile terminal 2900 by NFC tagging, the control unit 2810 may receive data necessary for registering use of the mobile terminal 2900 by using the NFC module 2820. In other words, the control unit 2810 may receive use registration information including user information used to register use of the mobile terminal 2900 from the mobile terminal 2900. The control unit 2810 may transmit a use registration result of the mobile terminal 2900 to the mobile terminal 2900 by using the NFC module 2820.

The control unit 2810 may store various types of programs and data in the storage unit 2830 or may receive the various types of programs and data from the storage unit 2830. The control unit 2810 may perform calculation or compare the data by using the data received from the storage unit 2830. For example, the control unit 2810 may compare the user information included in the use registration information received from the mobile terminal 2900 and a user profile stored in the storage unit 2830, perform user authentication, store the use registration information that is completely authenticated in the storage unit 2830, and register use of the mobile terminal 2900.

The control unit 2810 may configure a UI screen to determine information input from a user through the UI unit 2840 or to output a processing result according to control of the control unit 2810 to the UI unit 2840. For example, the control unit 2810 may control the UI unit 2840 to register use of the mobile terminal 2900 and display the use registration result.

The NFC module 2820 may perform NFC with an external device such as the mobile terminal 2900 by NFC tagging. When the external device such as the mobile terminal 2900 approaches the image forming apparatus 2800, the NFC module 2820 may perform NFC with an NFC module included in the external device such as the mobile terminal 2900 by NFC tagging within a predetermined distance.

For example, when the mobile terminal 2900 initially NFC tags the image forming apparatus 2800 within a predetermined distance to register use thereof, the NFC module 2820 may receive the use registration information including the user information from the mobile terminal 2900. The NFC module 2820 may transmit the result of the use registration of the mobile terminal 2900 that is performed in the image forming apparatus 2800 to the mobile terminal 2900.

The storage unit 2830 may store all types of programs and data that are generated according to an operation of the image forming apparatus 2800 or that are used during the operation of the image forming apparatus 2800. For example, the storage unit 2830 may store data generated by the operation of the image forming apparatus 2800 such as the data received from the external device, the data input through the UI unit 2840, the facsimile data, the scan data, and the print data or may store various types of programs and data used for control of the image forming apparatus 2800.

For example, the storage unit 2830 may store various types of data necessary for registering use of the external device such as the mobile terminal 2900. For example, the storage unit 2830 may store the user profile used to perform user authentication of the mobile terminal 2900. The storage unit 2830 may store the use registration information of the mobile terminal 2900 whose use may be registered after being completely authenticated.

The UI unit 2840 may display information to the user and receive information from the user. The UI unit 2840 may include an input/output apparatus such as a capacitive or piezoelectric touch screen, a display panel, a touch pad, or a keyboard, for example, which is provided in the image forming apparatus 2800. The UI unit 2840 may receive various inputs regarding use of the image forming apparatus 2800 from the user.

For example, the UI unit 2840 may receive data for registering use of the external device and display the use registration result to the user.

The image forming apparatus 2800 may further include the communication module 2850 according to a method of performing user authentication. The image forming apparatus 2800 may perform user authentication by using a user profile stored in the storage unit 2830 and by using an external server in which the user profile is stored. In the latter, the image forming apparatus 2800 may further include the communication module 2850 that is different from the NFC module 2820 to perform communication with the external server for user authentication. In this regard, the communication module 2850 may be a network module for connection to a network.

The control unit 2810 of the image forming apparatus 2800 may use the communication module 2850 to transmit the user information included in the use registration information received from the mobile terminal 2900 to the external server in which the user profile is stored, request user authentication for the mobile terminal 2900, receive a user authentication result from the external server, and perform user authentication.

The configurations and operations of the image forming apparatus 2800 and the mobile terminal 2900 that register use of the mobile terminal 2900 by transmitting the use registration information from the NFC module 2920 of the mobile terminal 2900 to the NFC module 2820 of the image forming apparatus 2800 are described with reference to FIGS. 30 through 32 above. The configurations and operations of the image forming apparatus 2800 and the mobile terminal 2900 that register use of the mobile terminal 2900 according to an embodiment will now be described below.

FIG. 33 illustrates the image forming apparatus 2800 and the mobile terminal 2900 that perform NFC and other wireless communication methods.

Referring to FIG. 33, the image forming apparatus 2800 and the mobile terminal 2900 that each support an NFC function are present. Regarding differences between the image forming apparatus 2800 and the mobile terminal 2900 of FIGS. 28 and 33, the image forming apparatus 2800 and the mobile terminal 2900 of FIG. 33 may further perform other wireless communication methods such as Wi-Fi Direct, Bluetooth, or ZigBee, for example, as well as NFC.

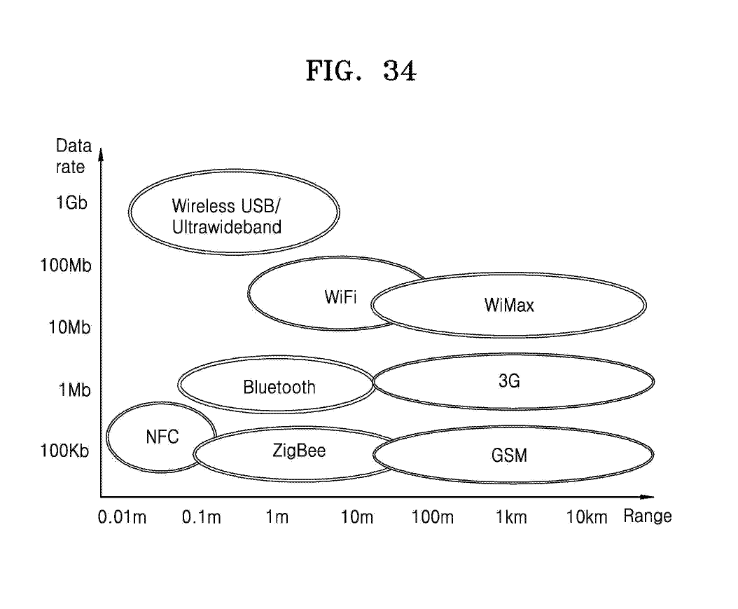

FIG. 34 is a graph for comparing data rates and communication ranges of NFC and other wireless communication methods.

Referring to FIG. 34, unlike other wireless communication methods, NFC may operate at a communication distance within approximately 10 cm. Unlike ZigBee, Bluetooth, Wi-Fi, etc., which allow communication within approximately several to several tens of meters, NFC allows communication only within an extremely short distance (approximately 10 cm). Compared to other wireless communication methods such as Bluetooth, Wi-Fi, etc., NFC has a low data rate. However, NFC operates only within a distance of 10 cm and encryption technology is applied thereto, and thus, a security level of NFC is high. Accordingly, when used in combination with other wireless communication methods, communication between devices via NFC may be performed with higher efficiency.

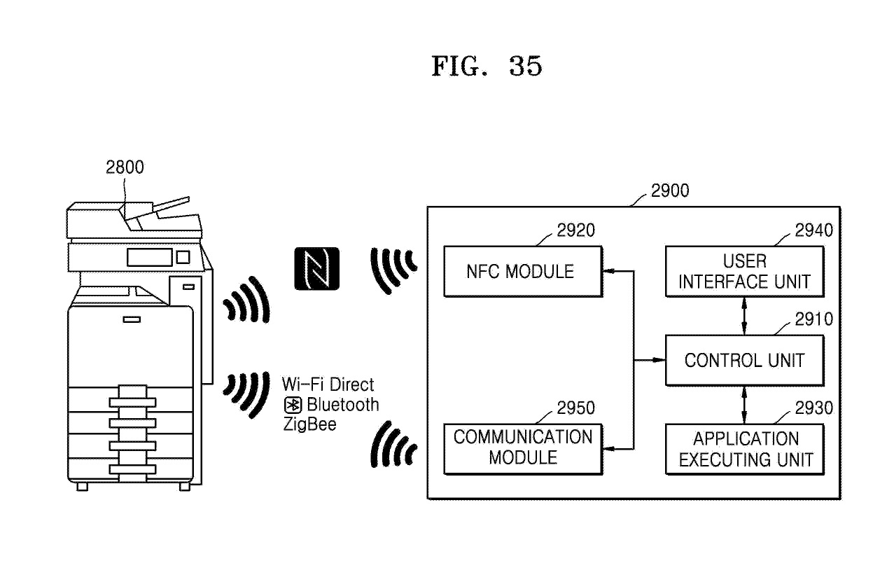

FIG. 35 is a diagram illustrating a structure of the mobile terminal 2900 supporting an NFC function according to an embodiment of the present disclosure.

Referring to FIG. 35, the mobile terminal 2900 may include the control unit 2910, the NFC module 2920, the application executing unit 2930, the UI unit 2940, and the communication module 2950. It will be understood by one of ordinary skill in the art that general-use components other than the components illustrated in FIG. 35 may also be included. Redundant descriptions between the mobile terminal 2900 of FIGS. 30 and 35 are omitted and only differences therebetween will now be described.

The communication module 2950 of the mobile terminal 2900 of FIG. 35 may support wireless communication methods such as WiFi Direct, Bluetooth, or ZigBee, for example. In other words, the mobile terminal 2900 of FIG. 35 may include two communication interfaces of the NFC module 2920 and the communication module 2950.

The control unit 2910 of the mobile terminal 2900 may use one of the NFC module 2920 and the communication module 2950 to transmit use registration information to the image forming apparatus 2800. The control unit 2910 of the mobile terminal 2900 may determine a module to perform communication from among the NFC module 2920 and the communication module 2950 based on at least one selected from the group consisting of a distance between the image forming apparatus 2800 and the mobile terminal 2900, a data rate of the use registration information, and a communication state of the image forming apparatus 2800 and the mobile terminal 2900.

The control unit 2910 of the mobile terminal 2900 may use both the NFC module 2920 and the communication module 2950 to transmit the use registration information to the image forming apparatus 2800. In other words, both the NFC module 2920 and the communication module 2950 may be used to transmit the use registration information to the image forming apparatus 2800 to register use of the mobile terminal 2900.

For example, the control unit 2910 of the mobile terminal 2900 may use the NFC module 2920 to obtain a wireless communication method used to perform a wireless communication with the image forming apparatus 2800 and may use the communication module 2950 to transmit the use registration information by the obtained wireless communication method. In this regard, the control unit 2910 of the mobile terminal 2900 may use the NFC module 2920 to request the image forming apparatus 2800 for communication, and receive a wireless communication method that is different from the NFC performed by the NFC module 2920 from the image forming apparatus 2800 in response to the request, thereby obtaining the wireless communication method used to perform the wireless communication with the image forming apparatus 2800.

As an example, when NFC performed using the NFC module 2920 is stopped, the control unit 2910 of the mobile terminal 2900 may use the communication module 2950 to transmit the use registration information to the image forming apparatus 2800. When NFC performed using the NFC module 2920 is stopped due to the mobile terminal 2900 going beyond a predetermined distance, the control unit 2910 of the mobile terminal 2900 may use the communication module 2950 to transmit the use registration information to the image forming apparatus 2800.

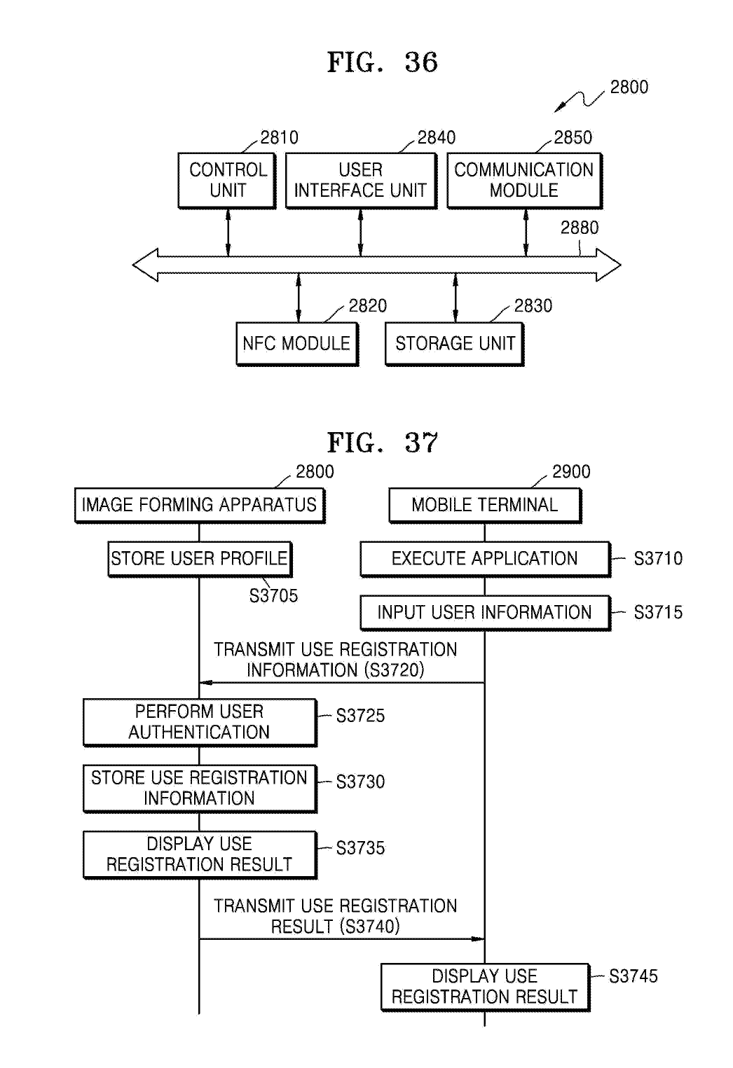

FIG. 36 is a diagram to explaining a structure of the image forming apparatus 2800 according to an embodiment of the present disclosure.

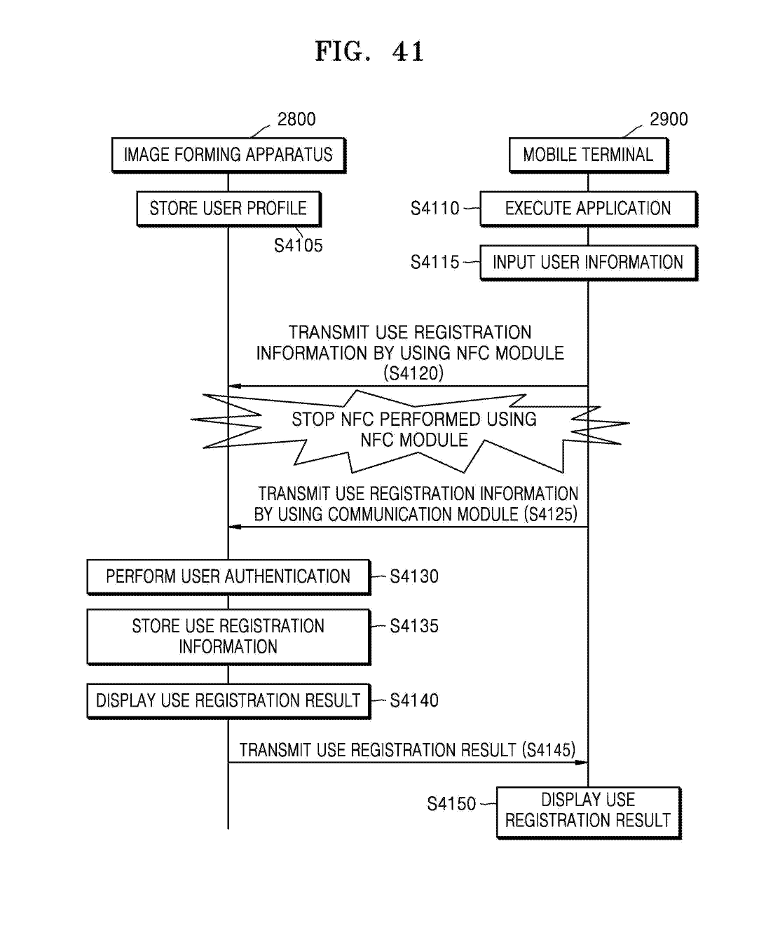

Referring to FIG. 36, the image forming apparatus 2800 may include the control unit 2810, the NFC module 2820, the storage unit 2830, the UI unit 2840, and the communication module 2850. It will be understood by one of ordinary skill in the art that general-use components other than the components illustrated in FIG. 36 may also be included. Redundant descriptions between the image forming apparatus 2800 of FIGS. 32 and 41 are omitted and only differences therebetween will now be described.

The communication module 2850 of the image forming apparatus 2800 of FIG. 36 may support wireless communication methods such as WiFi Direct, Bluetooth, ZigBee, etc. In other words, the image forming apparatus 2800 of FIG. 36 may include two communication interfaces of the NFC module 2820 and the communication module 2850.

The control unit 2810 of the image forming apparatus 2800 may use one of the NFC module 2820 and the communication module 2850 to transmit use registration information to the mobile terminal 2900. The control unit 2810 of the image forming apparatus 2800 may perform user authentication for registering use of the mobile terminal 2900 based on the received use registration information.

The control unit 2810 of the image forming apparatus 2800 may use both the NFC module 2820 and the communication module 2850 to receive the use registration information from the mobile terminal 2900. In other words, both the NFC module 2820 and the communication module 2850 may be used to receive the use registration information from the mobile terminal 2900 to register use of the mobile terminal 2900.

For example, the control unit 2810 of the image forming apparatus 2800 may use the NFC module 2820 to transmit a wireless communication method used to perform a wireless communication with the mobile terminal 2900 and may use the communication module 2850 to receive the use registration information by using the transmitted wireless communication method.

As an example, when NFC performed using the NFC module 2820 is stopped, the control unit 2810 of the image forming apparatus 2800 may use the communication module 2850 to receive the use registration information from the mobile terminal 2900 and may perform user authentication for registering use of the mobile terminal 2900 based on the received use registration information. When NFC performed using the NFC module 2820 is stopped due to the mobile terminal 2900 going beyond a predetermined distance, the control unit 2810 of the image forming apparatus 2800 may use the communication module 2850 to receive the use registration information from the mobile terminal 2900.

The configurations and operations of the image forming apparatus 2800 and the mobile terminal 2900 that register use of the mobile terminal 2900 are described with reference to FIGS. 35 and 36 above. Methods of registering use of the mobile terminal 2900 to the image forming apparatus 2800 by transmitting the use registration information from the mobile terminal 2900 to the image forming apparatus 2800 according to embodiments will be described with reference to FIGS. 37 through 41 below.

FIG. 37 is a flowchart of a method in which the mobile terminal 2900 supporting an NFC function requests the image forming apparatus 2800 to register use thereof, and the image forming apparatus 2800 registers use of the mobile terminal 2900, according to an embodiment of the present disclosure.

The image forming apparatus 2800 and the mobile terminal 2900 may perform NFC by using the NFC modules 2820 and 2920 respectively. When the image forming apparatus 2800 and the mobile terminal 2900 initially perform NFC, the following use registration process may be performed to register use of the mobile terminal 2900 to the image forming apparatus 2800.

The image forming apparatus 2800 may store a user profile in the storage unit 2830 (operation S3705). The user profile which is data necessary for user authentication to register use of the mobile terminal 2900 may include user information of a user who is allowed to use the image forming apparatus 2800.

The mobile terminal 2900 may execute an application that inputs the user information used to perform user authentication for registering use of the mobile terminal 2900 (operation S3710). When the application is executed, an interface screen that may input the user information used to perform user authentication for registering use of the mobile terminal 2900 on the UI unit 2940 of the mobile terminal 2900.

The mobile terminal 2900 may receive user information through the UI unit 2940 (operation S3715). If a user inputs his/her user information through the UI unit 2940 of the mobile terminal 2900, the user information corresponding to each of an ID, a password, a passcode, and a domain may be encrypted by using a specific encryption algorithm. In this regard, an application providing an interface for inputting the user information may further determine device information used to identify the mobile terminal 2900 so that the device information and the user information input through the UI unit 2940 may be encrypted. That is, use registration information including the user information may further include the device information used to identify the mobile terminal 2900 and may be encrypted before being transmitted to the image forming apparatus 2800.

The mobile terminal 2900 may use the NFC module 2920 to transmit the use registration information including the user information to the image forming apparatus 2800 (operation S3720). That is, the image forming apparatus 2800 may use the NFC module 2820 to receive the use registration information including the user information from the mobile terminal 2900. The image forming apparatus 2800 may register use of the mobile terminal 2900 based on the received use registration information.

The image forming apparatus 2800 may perform user authentication for registering use of the mobile terminal 2900 based on the received use registration information (operation S3725). To this end, the control unit 2810 of the image forming apparatus 2800 may perform user authentication by decrypting the encrypted use registration information by the application for inputting the user information executed in the mobile terminal 2900.

In more detail, the control unit 2810 of the image forming apparatus 2800 may perform user authentication by comparing the user profile that is stored in the storage unit 2830 and is used to perform user authentication with the user information included in the received use registration information. If the user information included in the use registration information received by the image forming apparatus 2800 and user information included in the user profile stored in the storage unit 2830 are identical to each other, a user of the mobile terminal 2900 is the user who is allowed to use the image forming apparatus 2800, thereby allowing use of the mobile terminal 2900 to be registered to the image forming apparatus 2800.

The image forming apparatus 2800 may store the use registration information whose user authentication is completed in the storage unit 2830 (operation S3730). The user information included in the use registration information and the device information used to identify the mobile terminal 2900 may be stored in the storage unit 2830 by corresponding the user information and the device information to each other. The use registration information whose user authentication is completed is stored in the storage unit 2830, and thus use of the mobile terminal 2900 may be completely registered to the image forming apparatus 2800. As described above, if use of the mobile terminal 2900 is registered to the image forming apparatus 2800, the image forming apparatus 2800 and the mobile terminal 2900 may perform NFC by NFC tagging.

The UI unit 2840 of the image forming apparatus 2800 may display a use registration result (operation S3735). When user authentication is successfully completed, the UI unit 2840 may display an acknowledge message that use of the mobile terminal 2900 has been registered to the image forming apparatus 2800. When user authentication fails, the UI unit 2840 may display an error message that the mobile terminal 2900 is not a mobile terminal of the user who is allowed to use the image forming apparatus 2800.

The image forming apparatus 2800 may use the NFC module 2820 to transmit the use registration result to the mobile terminal 2900 (operation S3740). That is, the mobile terminal 2900 may use the NFC module 2920 to receive the use registration result from the image forming apparatus 2800.

The UI unit 2940 of the mobile terminal 2900 may display the use registration result (operation S3745).

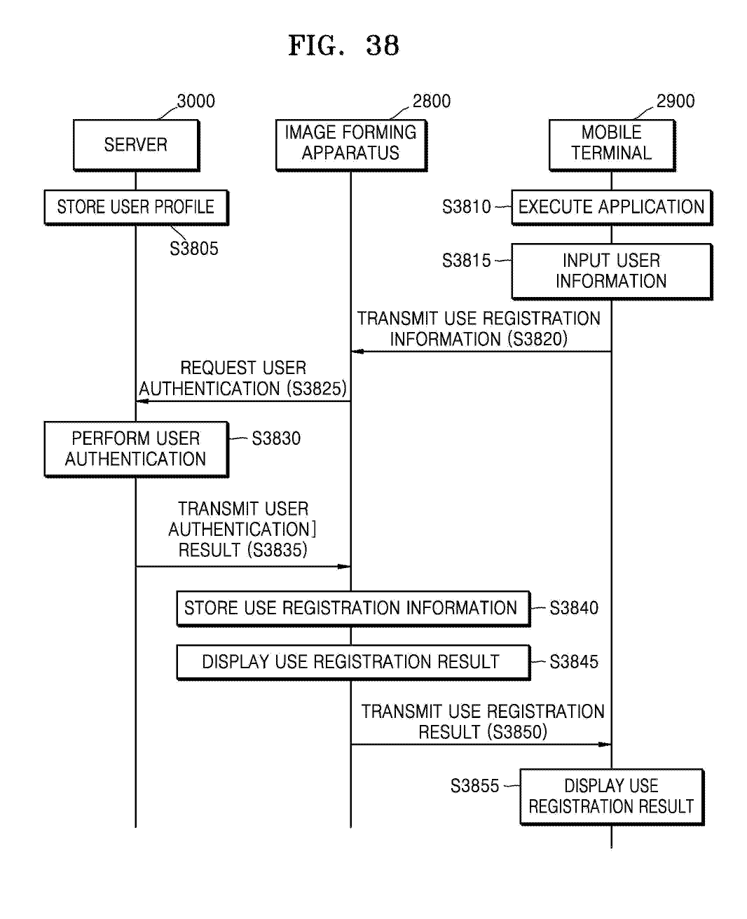

FIG. 38 is a flowchart of a method in which the mobile terminal 2900 supporting an NFC function requests the image forming apparatus 2800 to register use thereof, and the image forming apparatus 2800 registers use of the mobile terminal 2900 according to an embodiment of the present disclosure.

As described with reference to FIG. 37 above, the image forming apparatus 2800 and the mobile terminal 2900 may perform a use registration process to register use of the mobile terminal 2900 to the image forming apparatus 2800 during initial NFC between two devices. A server 3000 outside the image forming apparatus 2800 is used to perform user authentication in the present embodiment. The detailed description provided in the embodiment described with reference to FIG. 37 is omitted or described in brief, and only differences therebetween will now be described.

The server 3000 may store a user profile (operation S3805). The user profile, which is data for user authentication to register use of the mobile terminal 2900, may include user information of a user who is allowed to use the image forming apparatus 2800. The server 3000, which is Web-based, stores and manages the user profile necessary for user authentication in the present embodiment.

The mobile terminal 2900 may execute an application that inputs the user information used to perform user authentication for registering use of the mobile terminal 2900 (operation S3810).

The mobile terminal 2900 may receive user information from a user through the UI unit 2940 (operation S3815).

The mobile terminal 2900 may use the NFC module 2920 to transmit the use registration information including the user information to the image forming apparatus 2800 (operation S3820). That is, the image forming apparatus 2800 may use the NFC module 2820 to receive the use registration information including the user information from the mobile terminal 2900.

The image forming apparatus 2800 may request user authentication by transmitting the user information included in the use registration information received by the server 3000 in which the user profile used to perform user authentication is stored (operation S3825). To this end, the image forming apparatus 2800 may include the communication module 2850 used to perform communication with the server 3000.

The server 3000 may perform user authentication to register use of the mobile terminal 2900 based on the user information received from the image forming apparatus 2800 (operation S3830). In more detail, if the user information received by the server 3000 and user information included in the user profile stored in the server 3000 are identical to each other, a user of the mobile terminal 2900 is the user who is allowed to use the image forming apparatus 2800, thereby succeeding in user authentication.

The server 3000 may transmit a user authentication result to the image forming apparatus 2800 (operation S3835). In other words, the image forming apparatus 2800 may receive the user authentication result from the server 3000.

The image forming apparatus 2800 may store the use registration information whose user authentication is completed in the storage unit 2830 (operation S3840). The use registration information whose user authentication is completed is stored in the storage unit 2830, and thus use of the mobile terminal 2900 may be registered to the image forming apparatus 2800.

The UI unit 2840 of the image forming apparatus 2800 may display the use registration result (operation S3845).

The image forming apparatus 2800 may use the NFC module 2820 to transmit the use registration result to the mobile terminal 2900 (operation S3850). That is, the mobile terminal 2900 may use the NFC module 2920 to receive the use registration result from the image forming apparatus 2800.

The UI unit 2940 of the mobile terminal 2900 may display the use registration result of the mobile terminal 2900 (operation S3855).

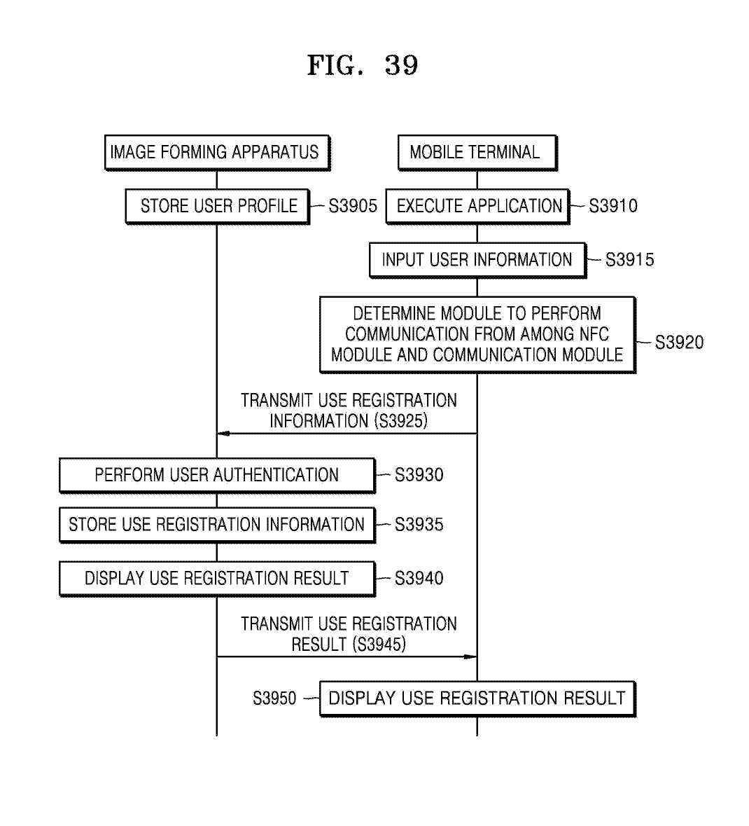

FIG. 39 is a flowchart of a method in which the mobile terminal 2900 supporting an NFC function requests the image forming apparatus 2800 to register use thereof, and the image forming apparatus 2800 registers use of the mobile terminal 2900 according to an embodiment of the present disclosure.

Like the embodiments described with reference to FIGS. 37 and 38 above, the communication modules 2850 and 2950 as well as the NFC modules 2820 and 2920 are used to transmit use registration information from the mobile terminal 2900 to the image forming apparatus 2800 in embodiments with reference to FIGS. 39 through 41. In this regard, the communication modules 2850 and 2950 are communication interfaces used to perform wireless communication that is different from the NFC performed by the NFC modules 2820 and 2920. The detailed description provided with reference to FIG. 37 is omitted or described in brief, and only differences therebetween will now be described.

The image forming apparatus 2800 may store a user profile in the storage unit 2830 (operation S3905).

The mobile terminal 2900 may execute an application that inputs user information used to perform user authentication for registering use of the mobile terminal 2900 to the image forming apparatus 2800 (operation S3910).

The mobile terminal 2900 may receive user information through the UI unit 2940 (operation S3915).

The mobile terminal 2900 may determine a module to perform communication with the image forming apparatus 2800 from among the NFC module 2920 and the communication module 2950 (operation S3920). In more detail, the control unit 2910 of the mobile terminal 2900 may determine the module to perform communication with the image forming apparatus 2800 from among the NFC module 2920 and the communication module 2950 based on at least one selected from the group consisting of a distance between the image forming apparatus 2800 and the mobile terminal 2900, a data rate of use registration information, and a communication state of the image forming apparatus 2800 and the mobile terminal 2900.

The mobile terminal 2900 may use one of the NFC module 2920 and the communication module 2950 to transmit the use registration information to the image forming apparatus 2800 (operation S3925). In other words, the image forming apparatus 2800 may use one of the NFC module 2920 and the communication module 2950 to receive the use registration information from the mobile terminal 2900.

The image forming apparatus 2800 may perform user authentication to register use of the mobile terminal 2900 based on the received user information (operation S3930). If user information included in the use registration information received by the image forming apparatus 2800 and user information included in the user profile stored in the storage unit 2830 are identical to each other, a user of the mobile terminal 2900 is a user who is allowed to use the image forming apparatus 2800, thereby allowing use of the mobile terminal 2900 to be registered to the image forming apparatus 2800.

The image forming apparatus 2800 may store the use registration information whose user authentication is completed in the storage unit 2830 (operation S3935). The use registration information whose user authentication is completed is stored in the storage unit 2830, and thus use of the mobile terminal 2900 may be completely registered to the image forming apparatus 2800.

The UI unit 2840 of the image forming apparatus 2800 may display a use registration result (operation S3940).

The image forming apparatus 2800 may use one of the NFC module 2820 and the communication module 2850 to transmit the use registration result to the mobile terminal 2900 (operation S3945). That is, the mobile terminal 2900 may use one of the NFC module 2820 and the communication module 2850 to receive the use registration result from the image forming apparatus 2800.

The UI unit 2940 of the mobile terminal 2900 may display the use registration result (operation S3950).

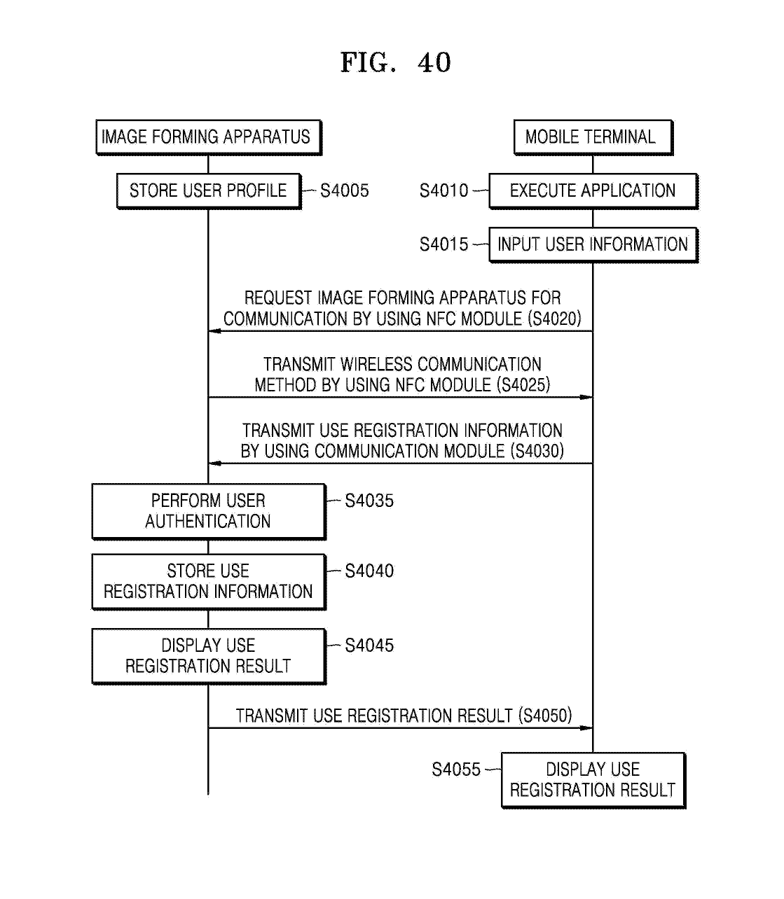

FIG. 40 is a flowchart of a method in which the mobile terminal 2900 supporting an NFC function requests the image forming apparatus 2800 to register use thereof, and the image forming apparatus 2800 registers use of the mobile terminal 2900 according to an embodiment of the present disclosure. The detailed description provided with reference to FIG. 37 is omitted or described in brief, and only differences therebetween will now be described.

The image forming apparatus 2800 may store a user profile in the storage unit 2830 (operation S4005).

The mobile terminal 2900 may execute an application that inputs user information used to perform user authentication for registering use of the mobile terminal 2900 to the image forming apparatus 2800 (operation S4010).

The mobile terminal 2900 may receive user information through the UI unit 2940 (operation S4015).

The mobile terminal 2900 may use the NFC module 2920 to obtain a wireless communication method used to perform a wireless communication with the image forming apparatus 2800, and may use the communication module 2950 to transmit use registration information including the user information input by the obtained wireless communication method.

In more detail, the mobile terminal 2900 may use the NFC module 2920 to request communication from the image forming apparatus 2800 (operation S4020).

The image forming apparatus 2800 may use the NFC module 2820 to transmit a wireless communication method used to perform the wireless communication with the mobile terminal 2900 (operation S4025). That is, the mobile terminal 2900 may receive a wireless communication method that is different from the NFC performed by the NFC module 2920 in response to a communication request.

The mobile terminal 2900 may use the communication module 2950 to transmit the use registration information by using the wireless communication method received from the image forming apparatus 2800 (operation S4030). That is, the image forming apparatus 2800 may use the communication module 2950 to receive the use registration information by using the wireless communication method transmitted from the image forming apparatus 2800. In this regard, the communication modules 2850 and 2950 are communication interfaces that may perform wireless communication that is different from the NFC performed by the NFC modules 2820 and 2920.

The image forming apparatus 2800 may perform user authentication to register use of the mobile terminal 2900 based on the received user information (operation S4035). If user information included in the use registration information received by the image forming apparatus 2800 and user information included in the user profile stored in the storage unit 2830 are identical to each other, a user of the mobile terminal 2900 is a user who is allowed to use the image forming apparatus 2800, thereby allowing use of the mobile terminal 2900 to be registered to the image forming apparatus 2800.

The image forming apparatus 2800 may store the use registration information whose user authentication is completed in the storage unit 2830 (operation S4040). The use registration information whose user authentication is completed is stored in the storage unit 2830, and thus use of the mobile terminal 2900 may be registered to the image forming apparatus 2800.

The UI unit 2840 of the image forming apparatus 2800 may display a use registration result (operation S4045).

The image forming apparatus 2800 may use the communication module 2850 to transmit the use registration result to the mobile terminal 2900 (operation S4050). That is, the mobile terminal 2900 may use the communication module 2850 to receive the use registration result from the image forming apparatus 2800.

The UI unit 2940 of the mobile terminal 2900 may display the use registration result (operation S4055).

FIG. 41 is a flowchart of a method in which the mobile terminal 2900 supporting an NFC function requests the image forming apparatus 2800 to register use thereof, and the image forming apparatus 2800 registers use of the mobile terminal 2900 according to an embodiment of the present disclosure. The detailed description provided with reference to FIG. 37 is omitted or described in brief, and only differences therebetween will now be described.

The image forming apparatus 2800 may store a user profile in the storage unit 2830 (operation S4105).

The mobile terminal 2900 may execute an application that inputs user information used to perform user authentication for registering use of the mobile terminal 2900 to the image forming apparatus 2800 (operation S4110).

The mobile terminal 2900 may receive user information through the UI unit 2940 (operation S4115).

The mobile terminal 2900 may use the NFC module 2920 to transmit use registration information (operation S4120). That is, the image forming apparatus 2800 may use the NFC module 2820 to receive the use registration information.

When the use registration information is transmitted from the mobile terminal 2900 to the image forming apparatus 2800 by using the NFC modules 2820 and 2920, NFC performed using the NFC modules 2820 and 2920 may be stopped for a variety of reasons. For example, when the mobile terminal 2900 goes beyond a predetermined distance within which NFC is possible from the image forming apparatus 2800, NFC performed using the NFC modules 2820 and 2920 may be stopped. When the use registration information using the NFC modules 2820 and 2920 is not completely transmitted and received due to NFC performed using the NFC modules 2820 and 2920 between the image forming apparatus 2800 and the mobile terminal 2900 being stopped as described above, the image forming apparatus 2800 and the mobile terminal 2900 perform communication by using the communication modules 2850 and 2950. In this regard, the communication modules 2850 and 2950 are communication interfaces that may perform wireless communication that is different from the NFC performed by the NFC modules 2820 and 2920.

The mobile terminal 2900 may use the communication module 2950 to transmit the use registration information (operation S4125). That is, the image forming apparatus 2800 may use the communication module 2850 to receive the use registration information. The use registration information using the communication modules 2850 and 2950 may be transmitted again from when NFC performed using the NFC modules 2820 and 2920 is stopped or may be transmitted from the beginning thereof.

The image forming apparatus 2800 may perform user authentication to register use of the mobile terminal 2900 based on the received use registration information (operation S4130). If user information included in the use registration information received by the image forming apparatus 2800 and user information included in the user profile stored in the storage unit 2830 are identical to each other, a user of the mobile terminal 2900 is a user who is allowed to use the image forming apparatus 2800, thereby allowing use of the mobile terminal 2900 to be registered to the image forming apparatus 2800.

The image forming apparatus 2800 may store the use registration information whose user authentication is completed in the storage unit 2830 (operation S4135). The use registration information whose user authentication is completed is stored in the storage unit 2830, and thus use of the mobile terminal 2900 may be registered to the image forming apparatus 2800.

The UI unit 2840 of the image forming apparatus 2800 may display a use registration result (operation S4140).

The image forming apparatus 2800 may use the communication module 2850 to transmit the use registration result to the mobile terminal 2900 (operation S4145). That is, the mobile terminal 2900 may use the communication module 2950 to receive the use registration result from the image forming apparatus 2800.

The UI unit 2940 of the mobile terminal 2900 may display the use registration result (operation S4150).

As described in FIGS. 39 through 41 above, storing of the user profile and performing of user authentication may be performed by using the external server 3000 provided as described with reference to FIG. 38.

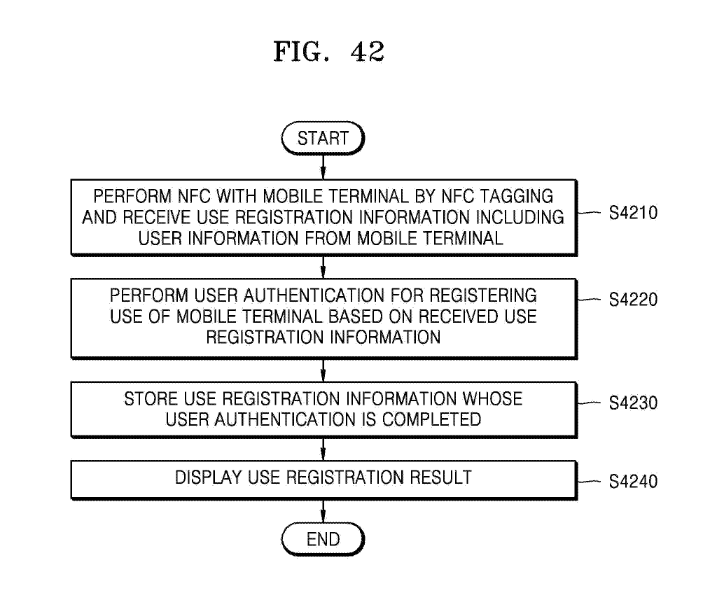

FIG. 42 is a flowchart of a method of registering use of the mobile terminal 2900 to the image forming apparatus 2800, according to an embodiment of the present disclosure. Although omitted below, details described regarding the image forming apparatus 2800 and the mobile terminal 2900 may also be applied to the method of registering use of the mobile terminal 2900 to the image forming apparatus 2800.

In operation S4210, the image forming apparatus 2800 may perform NFC with the mobile terminal 2900 by NFC tagging and receive use registration information including user information from the mobile terminal 2900. In this regard, the use registration information may further include device information used to identify the mobile terminal 2900.

When the image forming apparatus 2800 may include the communication module 2850 that performs wireless communication that is different from the NFC performed by the NFC module 2820, the communication module 2850 may be further used to receive the use registration information. The image forming apparatus 2800 may use one of the NFC module 2820 and the communication module 2850 to receive the use registration information from the mobile terminal 2900. According to circumstances, a communication interface of one of the NFC module 2820 and the communication module 2850 or both the NFC module 2820 and the communication module 2850 may be used to receive the use registration information from the mobile terminal 2900.

For example, the image forming apparatus 2800 may use the NFC module 2820 to transmit a wireless communication method used to perform the wireless communication with the mobile terminal 2900 to the mobile terminal 2900, and may use the communication module 2850 to receive the use registration information from the mobile terminal 2900 by using the wireless communication method transmitted from the image forming apparatus 2800. As an example, when NFC performed using the NFC module 2820 is stopped, the image forming apparatus 2800 may use the communication module 2850 to receive the use registration information from the mobile terminal 2900.

In operation S4220, the image forming apparatus 2800 may perform user authentication for registering use of the mobile terminal 2900 based on the received use registration information. A user profile used to perform user authentication may be stored in the image forming apparatus 2800 or the server 3000 provided outside. The image forming apparatus 2800 may perform user authentication by comparing the stored user profile used to perform user authentication with the user information included in the received use registration information. If the user information included in the use registration information received by the image forming apparatus 2800 and user information included in the stored user profile are identical to each other, registration of use of the mobile terminal 2900 to the image forming apparatus 2800 may be allowed.

In operation S4230, the image forming apparatus 2800 may store the use registration information whose user authentication is completed. The use registration information whose user authentication is completed is stored in the storage unit 2830, and thus use of the mobile terminal 2900 may be registered to the image forming apparatus 2800.

In operation S4240, the image forming apparatus 2800 may display a use registration result.

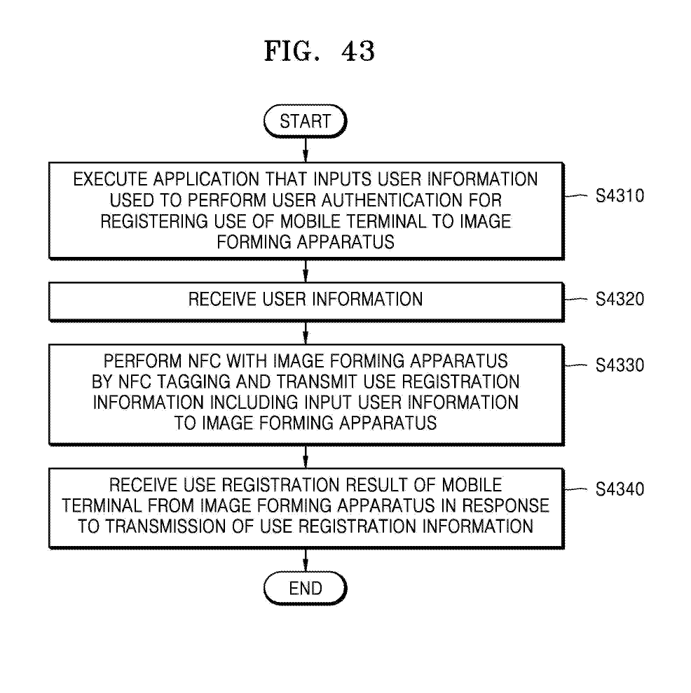

FIG. 43 is a flowchart of a method of requesting the image forming apparatus 2800 to register use of the mobile terminal 2900, according to an embodiment of the present disclosure. Although omitted below, details described regarding the image forming apparatus 2800 and the mobile terminal 2900 may also be applied to the method of requesting the image forming apparatus 2800 to register use of the mobile terminal 2900.

In operation S4310, the mobile terminal 2900 may execute an application that inputs user information used to perform user authentication for registering use of the mobile terminal 2900 to the image forming apparatus 2800. Accordingly, the mobile terminal 2900 may display an interface screen for inputting the user information used to perform user authentication for registering use of the mobile terminal 2900.

In operation S4320, the mobile terminal 2900 may receive the user information. The user information that a user inputs to the mobile terminal 2900 may include use registration information and device information that is used to identify the mobile terminal 2900 and is stored in the mobile terminal 2900 and may be encrypted before being transmitted to the image forming apparatus 2800.

In operation S4330, the mobile terminal 2900 may perform NFC with the image forming apparatus 2800 by NFC tagging and transmit the use registration information including the input user information to the image forming apparatus 2800.

When the mobile terminal 2900 includes the communication module 2950 that performs wireless communication that is different from the NFC performed by the NFC module 2920, the communication module 2950 may be further used to transmit the use registration information. The mobile terminal 2900 may use one of the NFC module 2920 and the communication module 2950 to transmit the use registration information to the image forming apparatus 2800. According to circumstances, a communication interface of one of the NFC module 2920 and the communication module 2950 or both the NFC module 2920 and the communication module 2950 may be used to transmit the use registration information to the image forming apparatus 2800.

For example, the mobile terminal 2900 may use the NFC module 2820 to obtain a wireless communication method used to perform a wireless communication with the image forming apparatus 2800 from the image forming apparatus 2800, and may use the communication module 2950 to transmit the use registration information to the image forming apparatus 2800 by using the wireless communication method obtained from the image forming apparatus 2800. As an example, when NFC performed using the NFC module 2920 is stopped, the mobile terminal 2900 may use the communication module 2950 to transmit the use registration information to the image forming apparatus 2800. In particular, when NFC performed using the NFC module 2920 is stopped due to the mobile terminal 2900 going beyond a predetermined distance from the image forming apparatus 2800, the mobile terminal 2900 may use the communication module 2950 to transmit the use registration information to the image forming apparatus 2800.

In operation S4340, the mobile terminal 2900 may receive a result of the use registration of the mobile terminal 2900 from the image forming apparatus 2800 in response to transmission of the use registration information.

As described above, according to the one or more of the above embodiments of the present disclosure, when a mobile terminal performs initial NFC with an image forming apparatus by NFC tagging, a method may be used to register use of the mobile terminal to the image forming apparatus without a manager, thereby extending use of services based on an NFC function.

It should be understood that the embodiments described herein should be considered in a descriptive sense only and not for purposes of limitation. Descriptions of features or aspects within each embodiment should typically be considered as available for other similar features or aspects in other embodiments.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

While one or more embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. An image forming apparatus that registers use of a mobile terminal that supports a near field communication (NFC) function, the image forming apparatus comprising:
an NFC interface to perform NFC with the mobile terminal by NFC tagging;
a controller to receive use registration information including user information from the mobile terminal by using the NFC interface and performing user authentication for registering use of the mobile terminal based on the received use registration information;
a storage unit to store the use registration information in which user authentication is completed; and
a user interface (UI) to display a use registration result.

2. The image forming apparatus of claim 1, wherein the use registration information comprises device information to identify the mobile terminal.

3. The image forming apparatus of claim 1, wherein the controller performs user authentication by decrypting the use registration information encrypted by an application that is executed in the mobile terminal and inputs the user information.

4. The image forming apparatus of claim 1, wherein the storage unit stores a user profile to perform user authentication, and
wherein the controller performs user authentication by comparing the user information included in the received use registration information with the user profile.

5. The image forming apparatus of claim 1, further comprising:
a communication interface to perform communication with a server in which a user profile to perform user authentication is stored,
wherein the controller performs user authentication by transmitting the user information included in the received use registration information to the server, requesting the server for user authentication, and receiving a use registration result from the server.

6. The image forming apparatus of claim 1, further comprising:
a communication interface to perform wireless communication that is different from the NFC performed by the NFC interface,
wherein the controller receives the use registration information from the mobile terminal by using one of the NFC interface and the communication interface and performs user authentication for registering use of the mobile terminal based on the received use registration information.

7. The image forming apparatus of claim 6, wherein the controller transmits a wireless communication method to perform the wireless communication with the mobile terminal by using the NFC interface and receives the use registration information by the transmitted wireless communication method by using the communication interface.

8. The image forming apparatus of claim 1, further comprising:
a communication interface to perform wireless communication that is different from the NFC performed by the NFC interface,
wherein the controller receives the use registration information from the mobile terminal by using the communication interface when NFC performed using the NFC interface is stopped and performs user authentication for registering use of the mobile terminal based on the received use registration information.

9. The image forming apparatus of claim 8, wherein the controller receives the use registration information from the mobile terminal by using the communication interface when the mobile terminal goes beyond a predetermined distance and NFC performed using the NFC interface is stopped.

10. A method of registering use of a mobile terminal that supports a near field communication (NFC) function, to an image forming apparatus, the method comprising:
performing NFC with the mobile terminal by NFC tagging, and receiving use registration information including user information from the mobile terminal;
performing user authentication for registering use of the mobile terminal based on the received use registration information;
storing the use registration information whose user authentication is completed; and
displaying a use registration result.

11. A mobile terminal supporting a near field communication (NFC) function, the mobile terminal comprising:
an application executor to execute an application that inputs user information to perform user authentication for registering use of the mobile terminal to an image forming apparatus;
a user interface (UI) to receive the user information;
an NFC interface to perform NFC with the image forming apparatus by NFC tagging; and
a controller to transmit use registration information including the input user information to the image forming apparatus by using the NFC interface and receiving a result of use registration of the mobile terminal from the image forming apparatus in response to transmission of the use registration information.

12. The mobile terminal of claim 11, wherein the use registration information comprises device information to identify the mobile terminal.

13. The mobile terminal of claim 11, wherein the controller transmits the use registration information encrypted by the application by using the NFC interface.

14. The mobile terminal of claim 11, further comprising:
a communication interface to perform wireless communication that is different from the NFC performed by the NFC interface,
wherein the controller transmits the use registration information to the image forming apparatus by using one of the NFC interface and the communication interface and receives a result of use registration of the mobile terminal from the image forming apparatus in response to transmission of the use registration information.

15. The mobile terminal of claim 14, wherein the controller determines a interface to perform communication from among the NFC interface and the communication interface based on at least one of a distance between the image forming apparatus and the mobile terminal, a data rate of the use registration information, and a communication state of the image forming apparatus and the mobile terminal.

16. The mobile terminal of claim 14, wherein the controller obtains a wireless communication method to perform the wireless communication with the image forming apparatus by using the NFC interface and transmits the use registration information by the obtained wireless communication method by using the communication interface.

17. The mobile terminal of claim 16, wherein the controller requests the image forming apparatus for communication by using the NFC interface and receives a wireless communication method that is different from the NFC performed by the NFC interface in response to a request to obtain the wireless communication method to perform the wireless communication with the image forming apparatus.

18. The mobile terminal of claim 11, further comprising:
a communication interface to perform wireless communication that is different from the NFC performed by the NFC interface,
wherein the controller transmits the use registration information to the image forming apparatus by using the communication interface when NFC performed using the NFC interface is stopped and receives a result of use registration of the mobile terminal from the image forming apparatus in response to the transmission of the use registration information.

19. The mobile terminal of claim 18, wherein the controller transmits the use registration information to the image forming apparatus by using the communication interface when the mobile terminal goes beyond a predetermined distance and NFC performed using the NFC interface is stopped.

20. A method of registering use of a mobile terminal supporting an NFC function to an image forming apparatus, the method comprising:
executing, by a processor, an application that inputs user information to perform user authentication for registering use of the mobile terminal to the image forming apparatus;
receiving the user information;
performing NFC with the image forming apparatus by NFC tagging, and transmitting use registration information including the input user information to the image forming apparatus; and
receiving a result of use registration of the mobile terminal from the image forming apparatus in response to transmission of the use registration information.
